(19) United States
(12) Patent Application Publication
(10) Pub. No.: US 2016/0330654 A1
(43) Pub. Date: Nov. 10, 2016

(54) COMMUNICATION METHOD ON BASIS OF LOWEST PRIORITY INFORMATION IN WIRELESS COMMUNICATION SYSTEM AND DEVICE FOR SUPPORTING SAME

(71) Applicant: LG ELECTRONICS INC., Seoul (KR)

(72) Inventors: Sunghoon JUNG, Seoul (KR); Youngdae LEE, Seoul (KR); Seungjune YI, Seoul (KR)

(73) Assignee: LG ELECTRONICS INC., Seoul (KR)

(21) Appl. No.: 15/112,005

(22) PCT Filed: Jan. 17, 2014
(86) PCT No.: PCT/KR2014/000514

§ 371 Date: Jul. 15, 2016

(51) Int. Cl. H04W 36/00; H04W 8/16

(52) U.S. Cl. CPC H04W 36/0016; H04W 8/16; H04W 92/20

(57) ABSTRACT

Provided is a communication method performed by a first base station in a wireless communication system. The method comprises: generating mobility restriction information related to the control of movement of a terminal; and transmitting the mobility restriction information to a second base station. The mobility restriction information is transmitted through an X2 interface between the first base station and the second base station.

### BACKGROUND OF THE INVENTION

1. Field of the Invention

The present invention is related to wireless communication and more specifically, a communication method based on mobility restriction information in a wireless communication system and a device supporting the method.

2. Related Art

3rd Generation Partnership Project (3GPP) long term evolution (LTE) which is enhancement of Universal Mobile Telecommunications System (UMTS) is introduced as 3GPP release 8. The 3GPP LTE uses orthogonal frequency division multiple access (OFDMA) in a downlink and uses Single Carrier-frequency division multiple access (SC-FDMA) in an uplink. Multiple input multiple output (MIMO) having a maximum of 4 antennas is adopted. In recent years, 3GPP LTE-Advanced (A) which is evolution of the 3GPP LTE has been discussed.

A user equipment (UE) can detect quality degradation of a service being provided in a current cell to the UE or detect a new cell capable of providing a better service from the UE's mobility as a mobile device. Therefore, the UE can move to the new cell, which is called UE's performing a movement.

While performing a cell reselection procedure, the UE selects a target cell on the basis of a frequency priority. The UE can obtain priority-related information through system information of the cell or through dedicated signaling. The UE attempts to connect to the target cell by transmitting a connection configuration message. Once connection to the target cell is completed, the UE can receive a service from the target cell.

Depending on a wireless communication environment, movement of a UE to a new network based on specific frequency and/or specific RAT (Radio Access Technology) can be restricted. In this case, the network can provide the UE with mobility information related to the restriction on the movement of the UE. For example, the network can lower the reselection priority for one or more specific frequencies and/or specific RATs and provide the UE with mobility restriction information related to the reselection priority lowered. The UE can perform a movement on the basis of the mobility restriction information, for which case movement to the corresponding frequency and/or RAT can be restricted.

Meanwhile, mobility restriction information set up by a specific network node may not be known to other network nodes. The UE may try to move to a different network node while operating on the basis of the received mobility restriction information, and not being aware of the mobility restriction information, the different network node may not be able to support operation of a relevant movement of the UE. Being unable to get a support for operation of a relevant movement from the different network node, the UE may fail to receive a normal service, or efficiency in terms of network operation may be degraded due to unnecessary signaling between the UE and/or network

### SUMMARY OF THE INVENTION

A technical objective of the present invention is to provide a communication method based on mobility restriction information in a wireless communication system and a device supporting the method.

In an aspect, a method for communication performed by a first base station in a wireless communication system is provided. The method comprises generating mobility restriction information related to movement control of a user equipment (UE) and transmitting the mobility restriction information to a second base station, wherein the mobility restriction information is transmitted between the first and the second base station through X2 interface.

The mobility restriction information may include lowest priority information, and the lowest priority information indicates that lowest priority is applied to at least one frequency or specific Radio Access Technology (RAT).

The lowest priority information may include a frequency list about the at least one frequency to which the lowest priority is applied.

The lowest priority information may include a frequency list about frequencies to which the lowest priority is not applied.

The mobility restriction information may further include lowest priority duration information, and the lowest priority duration information may specify duration for which the lowest priority is applied according to the lowest priority information.

The mobility restriction information may further includes lowest priority duration information, and the lowest priority duration information specifies duration for which network may be operated on the basis of the lowest priority information.

The mobility restriction information may include lowest priority release information which indicates that application of the lowest priority to one or more frequencies or particular Radio Access Technology (RAT) has been released.

The mobility restriction information may be transmitted being included in a handover preparation message which is transmitted while a handover preparation procedure for handing over a UE from the first base station to the second base station is being performed.

The method may further comprise receiving a request for transmitting the mobility restriction information from the second base station, wherein the mobility restriction information is transmitted in response to the request.

The first base station may be an evolved Node B (eNB) of Evolved-UMTS Terrestrial Radio Access Network (E-UTRAN), and the second base station may be a Node B of UTRAN.

The mobility restriction information may form a base for operating the second base station.

In another aspect, a user equipment (UE) is provided. The UE comprises a Radio Frequency (RF) unit transmitting and receiving a radio signal and a processor functionally combined with the RF unit, wherein the processor is configured to generate mobility restriction information related to movement control of a UE and to transmit the mobility restriction information to a network node, wherein the mobility restriction information is transmitted between the wireless device and the network node through X2 interface.

The mobility restriction information may include lowest priority information, and the lowest priority information may indicate that lowest priority is applied to at least one frequency or specific Radio Access Technology (RAT).

According to the present invention, mobility restriction information is transmitted to the target network node, and thereby target network node may know lowest priority configuration for movement of a user equipment (UE). The target network node may know RRC connection establishment, handover, RRC configuration etc. on the basis of the received mobility restriction information. According to this one, more efficient service may be provided to the UE because the UE can move to the appropriate cell in an aspect of service provision. Moreover, efficiency is improved in an aspect of operating network because unnecessary signaling between the UE and network and/or between the network and another network is prevented.

### BRIEF DESCRIPTION OF THE DRAWINGS

FIG. 1 shows a wireless communication system to which the present invention is applied.

FIG. 2 is a diagram showing a wireless protocol architecture for a user plane.

FIG. 3 is a diagram showing a wireless protocol architecture for a control plane.

FIG. 4 is a flowchart illustrating the operation of UE in the RRC idle state.

FIG. 5 is a flowchart illustrating a process of establishing RRC connection.

FIG. 6 is a flowchart illustrating an RRC connection reconfiguration process.

FIG. 7 is a flow diagram illustrating a handover procedure.

FIG. 8 is a diagram illustrating an RRC connection re-establishment procedure.

FIG. 9 is a flow diagram illustrating a conventional method for performing measurement.

FIG. 10 illustrates one example of measurement configuration applied to a UE.

FIG. 11 illustrates an example of deleting a measurement identifier.

FIG. 12 illustrates an example of deleting a measurement object.

FIG. 13 illustrates an example problem that can occur due to a movement of a UE.

FIG. 14 illustrates a communication method based on mobility restriction information according to an embodiment of the present invention.

FIG. 15 illustrates one example of a communication method based on mobility restriction information according to an embodiment of the present invention.

FIG. 16 illustrates another example of a communication method based on mobility restriction information according to an embodiment of the present invention.

FIG. 17 illustrates a yet another example of a communication method based on mobility restriction information according to an embodiment of the present invention.

FIG. 18 is a block diagram of a wireless device to which an embodiment of the present invention is implemented.

### DESCRIPTION OF EXEMPLARY EMBODIMENTS

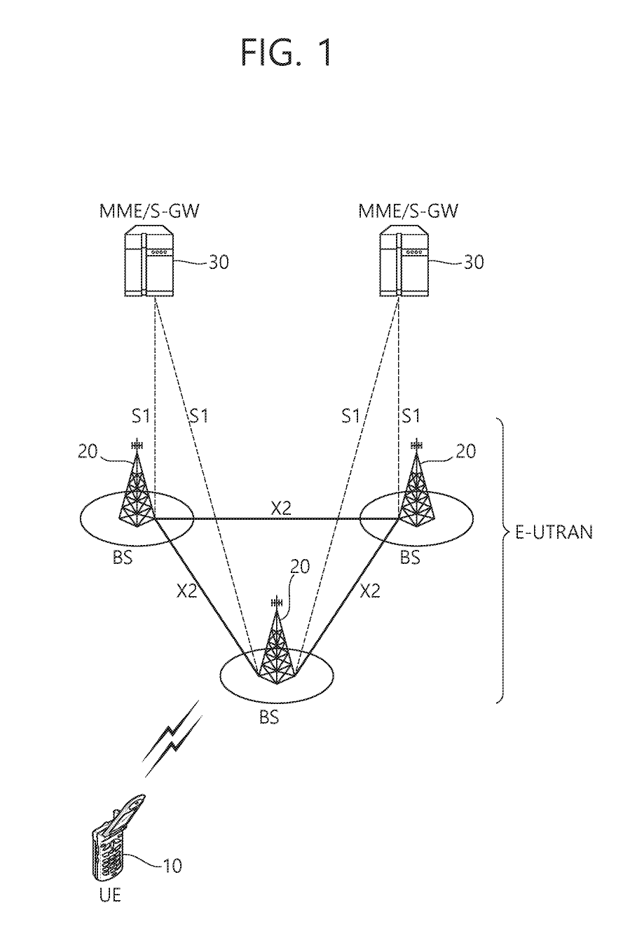

FIG. 1 shows a wireless communication system to which the present invention is applied. The wireless communication system may also be referred to as an evolved-UMTS terrestrial radio access network (E-UTRAN) or a long term evolution (LTE)/LTE-A system.

The E-UTRAN includes at least one base station (BS) 20 which provides a control plane and a user plane to a user equipment (UE) 10. The UE 10 may be fixed or mobile, and may be referred to as another terminology, such as a mobile station (MS), a user terminal (UT), a subscriber station (SS), a mobile terminal (MT), a wireless device, etc. The BS 20 is generally a fixed station that communicates with the UE 10 and may be referred to as another terminology, such as an evolved node-B (eNB), a base transceiver system (BTS), an access point, etc.

The BSs 20 are interconnected by means of an X2 interface. The BSs 20 are also connected by means of an S1 interface to an evolved packet core (EPC) 30, more specifically, to a mobility management entity (MME) through S1-MME and to a serving gateway (S-GW) through S1-U.

The EPC 30 includes an MME, an S-GW, and a packet data network-gateway (P-GW). The MME has access information of the UE or capability information of the UE, and such information is generally used for mobility management of the UE. The S-GW is a gateway having an E-UTRAN as an end point. The P-GW is a gateway having a PDN as an end point.

Layers of a radio interface protocol between the UE and the network can be classified into a first layer (L1), a second layer (L2), and a third layer (L3) based on the lower three layers of the open system interconnection (OSI) model that is well-known in the communication system. Among them, a physical (PHY) layer belonging to the first layer provides an information transfer service by using a physical channel, and a radio resource control (RRC) layer belonging to the third layer serves to control a radio resource between the UE and the network. For this, the RRC layer exchanges an RRC message between the UE and the BS.

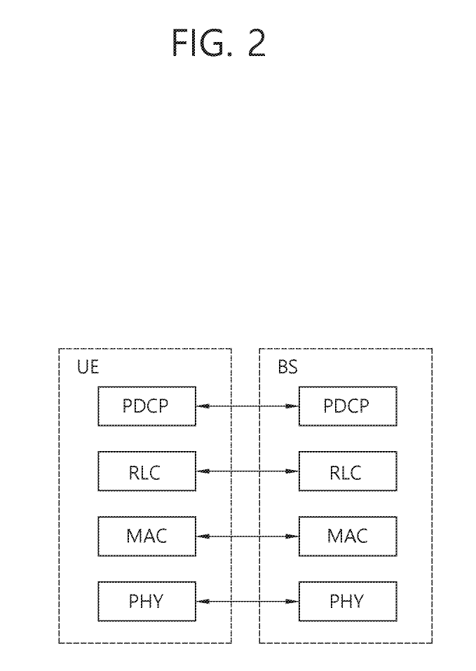

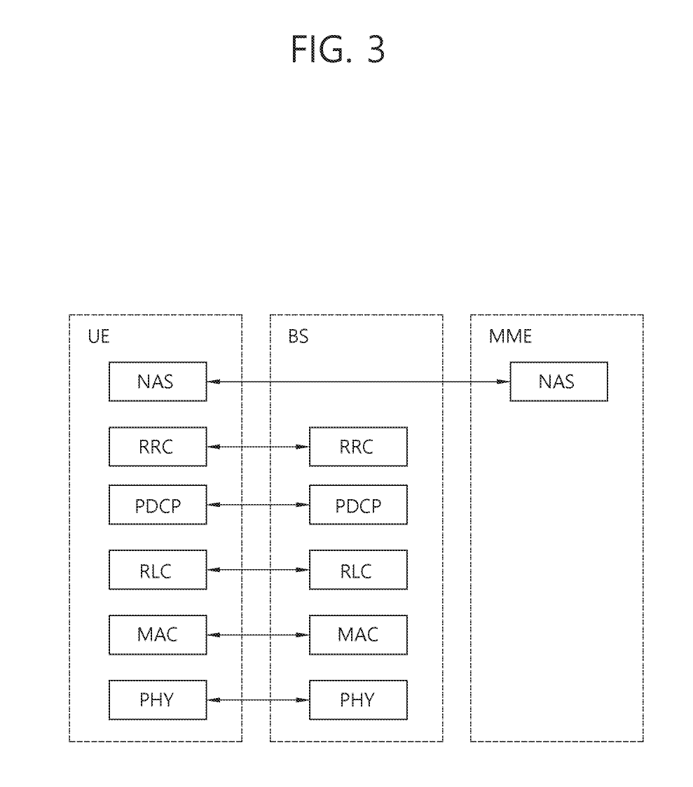

FIG. 2 is a diagram showing a wireless protocol architecture for a user plane. FIG. 3 is a diagram showing a wireless protocol architecture for a control plane. The user plane is a protocol stack for user data transmission. The control plane is a protocol stack for control signal transmission.

Referring to FIGS. 2 and 3, a PHY layer provides an upper layer with an information transfer service through a physical channel. The PHY layer is connected to a medium access control (MAC) layer which is an upper layer of the PHY layer through a transport channel. Data is transferred between the MAC layer and the PHY layer through the transport channel. The transport channel is classified according to how and with what characteristics data is transferred through a radio interface.

Data is moved between different PHY layers, that is, the PHY layers of a transmitter and a receiver, through a physical channel. The physical channel may be modulated according to an Orthogonal Frequency Division Multiplexing (OFDM) scheme, and use the time and frequency as radio resources.

The functions of the MAC layer include mapping between a logical channel and a transport channel and multiplexing and demultiplexing to a transport block that is provided through a physical channel on the transport channel of a MAC Service Data Unit (SDU) that belongs to a logical channel. The MAC layer provides service to a Radio Link Control (RLC) layer through the logical channel.

The functions of the RLC layer include the concatenation, segmentation, and reassembly of an RLC SDU. In order to guarantee various types of Quality of Service (QoS) required by a Radio Bearer (RB), the RLC layer provides three types of operation mode: Transparent Mode (TM), Unacknowledged Mode (UM), and Acknowledged Mode (AM). AM RLC provides error correction through an Automatic Repeat Request (ARQ).

The RRC layer is defined only on the control plane. The RRC layer is related to the configuration, reconfiguration, and release of radio bearers, and is responsible for control of logical channels, transport channels, and PHY channels. An RB means a logical route that is provided by the first layer (PHY layer) and the second layers (MAC layer, the RLC layer, and the PDCP layer) in order to transfer data between UE and a network.

The function of a Packet Data Convergence Protocol (PDCP) layer on the user plane includes the transfer of user data and header compression and ciphering. The function of the PDCP layer on the user plane further includes the transfer and encryption/integrity protection of control plane data.

What an RB is configured means a process of defining the characteristics of a wireless protocol layer and channels in order to provide specific service and configuring each detailed parameter and operating method. An RB can be divided into two types of a Signaling RB (SRB) and a Data RB (DRB). The SRB is used as a passage through which an RRC message is transmitted on the control plane, and the DRB is used as a passage through which user data is transmitted on the user plane.

If RRC connection is established between the RRC layer of UE and the RRC layer of an E-UTRAN, the UE is in the RRC connected state. If not, the UE is in the RRC idle state.

A downlink transport channel through which data is transmitted from a network to UE includes a broadcast channel (BCH) through which system information is transmitted and a downlink shared channel (SCH) through which user traffic or control messages are transmitted. Traffic or a control message for downlink multicast or broadcast service may be transmitted through the downlink SCH, or may be transmitted through an additional downlink multicast channel (MCH). Meanwhile, an uplink transport channel through which data is transmitted from UE to a network includes a random access channel (RACH) through which an initial control message is transmitted and an uplink shared channel (SCH) through which user traffic or control messages are transmitted.

Logical channels that are placed over the transport channel and that are mapped to the transport channel include a broadcast control channel (BCCH), a paging control channel (PCCH), a common control channel (CCCH), a multicast control channel (MCCH), and a multicast traffic channel (MTCH).

The physical channel includes several OFDM symbols in the time domain and several subcarriers in the frequency domain. One subframe includes a plurality of OFDM symbols in the time domain. An RB is a resources allocation unit, and includes a plurality of OFDM symbols and a plurality of subcarriers. Furthermore, each subframe may use specific subcarriers of specific OFDM symbols (e.g., the first OFDM symbol) of the corresponding subframe for a physical downlink control channel (PDCCH), that is, an L1/L2 control channel. A Transmission Time Interval (TTI) is a unit time for subframe transmission.

As disclosed in 3GPP TS 36.211 V8.7.0, in 3GPP LTE, a physical channel may be divided into Physical Downlink Shared Channel (PDSCH) and Physical Uplink Shared Channel (PUSCH) which are data channels and Physical Downlink Control Channel (PDCCH), Physical Control Format Indicator Channel (PCFICH), Physical Hybrid-ARQ Indicator Channel (PHICH) and Physical Uplink Control Channel (PUCCH) which are control channels.

The PCFICH transmitted in a first OFDM symbol of a subframe transports a control format indicator (CFI) regarding the number (that is, the size of a control region) of OFDM symbols used for transmitting the control channels in the subframe. The terminal first receives the CFI on the PCFICH and thereafter, monitors the PDCCH.

The PDCCH as a downlink control channel is also referred to as a scheduling channel in terms of transporting scheduling information. Control information transmitted through the PDCCH is referred to as downlink control information (DCI). The DCI may include resource allocation (this is also referred to as a downlink (DL) grant) of the PDSCH, resource allocation (this is also referred to as an uplink (UL) grant) of the PUSCH, a set of transmission power control commands for individual UEs in a predetermined UE group, and/activation of voice over Internet protocol (VoIP).

In the 3GPP LTE, blind decoding is used for detecting the PDCCH. The blind decoding is a scheme that demasks cyclic redundancy check (CRC) of the received PDCCH (this is referred to as a candidate PDCCH) with a desired identifier and checks a CRC error to verify whether the corresponding PDCCH is the control channel thereof.

A base station determines a PDCCH format according to the DCI which the base station is to transmit to the terminal and thereafter, attaches the CRC to the DCI and demasks the CRC with a unique identifier (this is referred to as a radio network temporary identifier (RNTI) according to an owner or a purpose of the PDCCH.

The RRC state of UE and an RRC connection method are described below.

The RRC state means whether or not the RRC layer of UE is logically connected to the RRC layer of the E-UTRAN. A case where the RRC layer of UE is logically connected to the RRC layer of the E-UTRAN is referred to as an RRC connected state. A case where the RRC layer of UE is not logically connected to the RRC layer of the E-UTRAN is referred to as an RRC idle state. The E-UTRAN may check the existence of corresponding UE in the RRC connected state in each cell because the UE has RRC connection, so the UE may be effectively controlled. In contrast, the E-UTRAN is unable to check UE in the RRC idle state, and a Core Network (CN) manages UE in the RRC idle state in each tracking area, that is, the unit of an area greater than a cell. That is, the existence or non-existence of UE in the RRC idle state is checked only for each large area. Accordingly, the UE needs to shift to the RRC connected state in order to be provided with common mobile communication service, such as voice or data.

When a user first powers UE, the UE first searches for a proper cell and remains in the RRC idle state in the corresponding cell. The UE in the RRC idle state establishes RRC connection with an E-UTRAN through an RRC connection procedure when it is necessary to set up the RRC connection, and shifts to the RRC connected state. A case where UE in the RRC idle state needs to set up RRC connection includes several cases. For example, the cases may include a need to send uplink data for a reason, such as a call attempt by a user, and to send a response message as a response to a paging message received from an E-UTRAN.

A Non-Access Stratum (NAS) layer placed over the RRC layer performs functions, such as session management and mobility management.

In the NAS layer, in order to manage the mobility of UE, two types of states: EPS Mobility Management-REGISTERED (EMM-REGISTERED) and EMM-DEREGISTERED are defined. The two states are applied to UE and the MME. UE is initially in the EMM-DEREGISTERED state. In order to access a network, the UE performs a process of registering it with the corresponding network through an initial attach procedure. If the attach procedure is successfully performed, the UE and the MME become the EMM-REGISTERED state.

In order to manage signaling connection between UE and the EPC, two types of states: an EPS Connection Management (ECM)-IDLE state and an ECM-CONNECTED state are defined. The two states are applied to UE and the MME. When the UE in the ECM-IDLE state establishes RRC connection with the E-UTRAN, the UE becomes the ECM-CONNECTED state. The MME in the ECM-IDLE state becomes the ECM-CONNECTED state when it establishes S1 connection with the E-UTRAN. When the UE is in the ECM-IDLE state, the E-UTRAN does not have information about the context of the UE. Accordingly, the UE in the ECM-IDLE state performs procedures related to UE-based mobility, such as cell selection or cell reselection, without a need to receive a command from a network. In contrast, when the UE is in the ECM-CONNECTED state, the mobility of the UE is managed in response to a command from a network. If the location of the UE in the ECM-IDLE state is different from a location known to the network, the UE informs the network of its corresponding location through a tracking area update procedure.

System information is described below.

System information includes essential information that needs to be known by UE in order for the UE to access a BS. Accordingly, the UE needs to have received all pieces of system information before accessing the BS, and needs to always have the up-to-date system information. Furthermore, the BS periodically transmits the system information because the system information is information that needs to be known by all UEs within one cell. The system information is divided into a Master Information Block (MIB) and a plurality of System Information Blocks (SIBs).

The MIB may include a limited number of parameters that are most essential and most frequently transmitted when other information is required to be obtained from a cell. UE first searches for an MIB after downlink synchronization. The MIB may include information, such as an SFN that supports downlink channel bandwidth, a PHICH configuration, and synchronization and operates as a timing criterion and an eNB transmit antenna configuration. The MIB may be transmitted on a broadcast channel (BCH) through broadcasting.

SystemInformationBlockType1 (SIB1) of included SIBs is included in a “SystemInformationBlockType1” message and transmitted. The remaining SIBs other than the SIB1 is included in a system information message and transmitted. To map the SIBs to the system information message may be flexibly configured by a scheduling information list parameter included in the SIB1. In this case, each of the SIBs is included in a single system information message, and only SIBs having the same scheduling requirement value (e.g. cycle) may be mapped to the same system information message. Furthermore, a SystemInformationBlockType2 (SIB2) is always mapped to a system information message corresponding to the first entry within the system information message list of a scheduling information list. A plurality of system information messages may be transmitted within the same cycle. The SIB1 and all the system information messages are transmitted on a DL-SCH.

In addition to broadcast transmission, in an E-UTRAN, the SIB1 may be dedicated-signaled in the state in which it includes a parameter configured like an existing configured value. In this case, the SIB1 may be included in an RRC connection reconfiguration message and transmitted.

The SIB1 includes information related to UE cell access, and defines the scheduling of other SIBs. The SIB1 may include information related to the PLMN identifiers of a network, tracking area code (TAC) and a cell ID, a cell barring status indicative of whether a cell is a cell on which camp-on is possible, the lowest reception level required within a cell which is used as cell reselection criterion, and the transmission time and cycle of other SIBs.

The SIB2 may include radio resource configuration information common to all pieces of UE. The SIB2 may include information related to an uplink carrier frequency and uplink channel bandwidth, an RACH configuration, a page configuration, an uplink power control configuration, a sounding reference signal configuration, a PUCCH configuration supporting ACK/NACK transmission, and a PUSCH configuration.

UE may apply a procedure for obtaining system information and detecting a change of system information to a primary cell (PCell) only. In a secondary cell (SCell), when a corresponding SCell is added, an E-UTRAN may provide all of pieces of system information related to an RRC connection state operation through dedicated signaling. When system information related to a configured SCell is changed, an E-UTRAN may release an SCell that is taken into consideration and subsequently add the changed system information. This may be performed along with a single RRC connection reconfiguration message. An E-UTRAN may configure parameter values different from a value broadcasted within an SCell that has been taken into consideration through dedicated signaling.

UE needs to guarantee the validity of a specific type of system information, and such system information is called required system information. The required system information may be defined as follows.
If UE is an RRC idle state: The UE needs to be guaranteed so that it has the valid versions of the MIB and the SIB1 in addition to the SIB2 to SIB8. This may comply with the support of a radio access technology (RAT) that is taken into consideration.
If UE is an RRC connection state: The UE needs to be guaranteed so that it has the valid versions of the MIB, the SIB1, and the SIB2.

In general, the validity of system information may be guaranteed up to a maximum of 3 hours after the system information is obtained.

In general, service that is provided to UE by a network may be classified into three types as follows. Furthermore, the UE differently recognizes the type of cell depending on what service may be provided to the UE. In the following description, a service type is first described, and the type of cell is described.

1) Limited service: this service provides emergency calls and an Earthquake and Tsunami Warning System (ETWS), and may be provided by an acceptable cell.

2) Suitable service: this service means public service for common uses, and may be provided by a suitable cell (or a normal cell).

3) Operator service: this service means service for communication network operators. This cell may be used by only communication network operators, but may not be used by common users.

In relation to a service type provided by a cell, the type of cell may be classified as follows.

1) An acceptable cell: this cell is a cell from which UE may be provided with limited service. This cell is a cell that has not been barred from a viewpoint of corresponding UE and that satisfies the cell selection criterion of the UE.

2) A suitable cell: this cell is a cell from which UE may be provided with suitable service. This cell satisfies the conditions of an acceptable cell and also satisfies additional conditions. The additional conditions include that the suitable cell needs to belong to a Public Land Mobile Network (PLMN) to which corresponding UE may access and that the suitable cell is a cell on which the execution of a tracking area update procedure by the UE is not barred. If a corresponding cell is a CSG cell, the cell needs to be a cell to which UE may access as a member of the CSG.

3) A barred cell: this cell is a cell that broadcasts information indicative of a barred cell through system information.

4) A reserved cell: this cell is a cell that broadcasts information indicative of a reserved cell through system information.

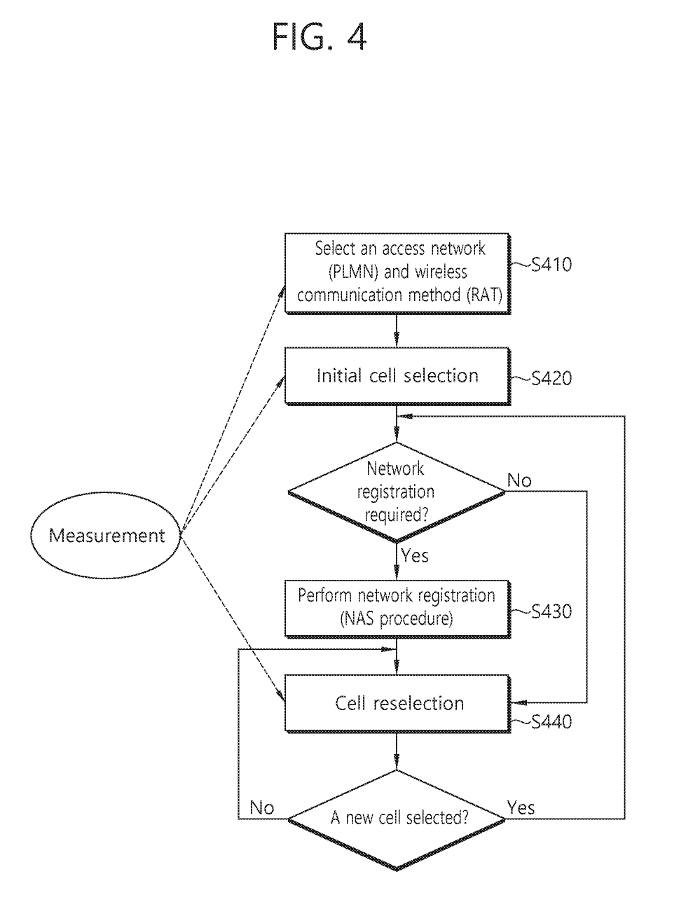

FIG. 4 is a flowchart illustrating the operation of UE in the RRC idle state. FIG. 4 illustrates a procedure in which UE that is initially powered on experiences a cell selection process, registers it with a network, and then performs cell reselection if necessary.

Referring to FIG. 4, the UE selects Radio Access Technology (RAT) in which the UE communicates with a Public Land Mobile Network (PLMN), that is, a network from which the UE is provided with service (S410). Information about the PLMN and the RAT may be selected by the user of the UE, and the information stored in a Universal Subscriber Identity Module (USIM) may be used.

The UE selects a cell that has the greatest value and that belongs to cells having measured BS and signal intensity or quality greater than a specific value (cell selection) (S420). In this case, the UE that is powered off performs cell selection, which may be called initial cell selection. A cell selection procedure is described later in detail. After the cell selection, the UE receives system information periodically by the BS. The specific value refers to a value that is defined in a system in order for the quality of a physical signal in data transmission/reception to be guaranteed. Accordingly, the specific value may differ depending on applied RAT.

If network registration is necessary, the UE performs a network registration procedure (S430). The UE registers its information (e.g., an IMSI) with the network in order to receive service (e.g., paging) from the network. The UE does not register it with a network whenever it selects a cell, but registers it with a network when information about the network (e.g., a Tracking Area Identity (TAI)) included in system information is different from information about the network that is known to the UE.

The UE performs cell reselection based on a service environment provided by the cell or the environment of the UE (S440). If the value of the intensity or quality of a signal measured based on a BS from which the UE is provided with service is lower than that measured based on a BS of a neighboring cell, the UE selects a cell that belongs to other cells and that provides better signal characteristics than the cell of the BS that is accessed by the UE. This process is called cell reselection differently from the initial cell selection of the No. 2 process. In this case, temporal restriction conditions are placed in order for a cell to be frequently reselected in response to a change of signal characteristic. A cell reselection procedure is described later in detail.

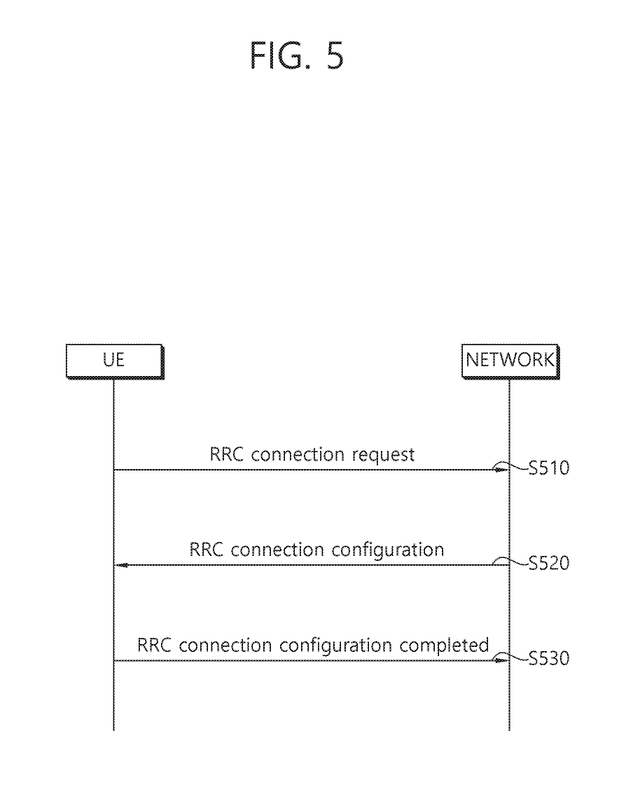

FIG. 5 is a flowchart illustrating a process of establishing RRC connection.

UE sends an RRC connection request message that requests RRC connection to a network (S510). The network sends an RRC connection establishment message as a response to the RRC connection request (S520). After receiving the RRC connection establishment message, the UE enters RRC connected mode.

The UE sends an RRC connection establishment complete message used to check the successful completion of the RRC connection to the network (S530).

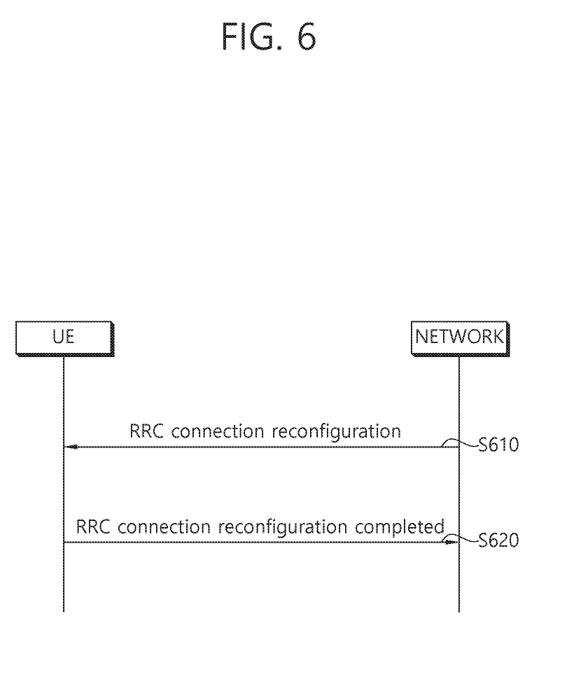

FIG. 6 is a flowchart illustrating an RRC connection reconfiguration process. An RRC connection reconfiguration is used to modify RRC connection. This is used to establish/modify/release RBs, perform handover, and set up/modify/release measurements.

A network sends an RRC connection reconfiguration message for modifying RRC connection to UE (S610). As a response to the RRC connection reconfiguration message, the UE sends an RRC connection reconfiguration complete message used to check the successful completion of the RRC connection reconfiguration to the network (S620).

Hereinafter, a public land mobile network (PLMN) is described.

The PLMN is a network which is disposed and operated by a mobile network operator. Each mobile network operator operates one or more PLMNs. Each PLMN may be identified by a Mobile Country Code (MCC) and a Mobile Network Code (MNC). PLMN information of a cell is included in system information and broadcasted.

In PLMN selection, cell selection, and cell reselection, various types of PLMNs may be considered by the terminal.

Home PLMN (HPLMN): PLMN having MCC and MNC matching with MCC and MNC of a terminal IMSI.

Equivalent HPLMN (EHPLMN): PLMN serving as an equivalent of an HPLMN.

Registered PLMN (RPLMN): PLMN successfully finishing location registration.

Equivalent PLMN (EPLMN): PLMN serving as an equivalent of an RPLMN.

Each mobile service consumer subscribes in the HPLMN. When a general service is provided to the terminal through the HPLMN or the EHPLMN, the terminal is not in a roaming state. Meanwhile, when the service is provided to the terminal through a PLMN except for the HPLMN/EHPLMN, the terminal is in the roaming state. In this case, the PLMN refers to a Visited PLMN (VPLMN).

When UE is initially powered on, the UE searches for available Public Land Mobile Networks (PLMNs) and selects a proper PLMN from which the UE is able to be provided with service. The PLMN is a network that is deployed or operated by a mobile network operator. Each mobile network operator operates one or more PLMNs. Each PLMN may be identified by Mobile Country Code (MCC) and Mobile Network Code (MNC). Information about the PLMN of a cell is included in system information and broadcasted. The UE attempts to register it with the selected PLMN. If registration is successful, the selected PLMN becomes a Registered PLMN (RPLMN). The network may signalize a PLMN list to the UE. In this case, PLMNs included in the PLMN list may be considered to be PLMNs, such as RPLMNs. The UE registered with the network needs to be able to be always reachable by the network. If the UE is in the ECM-CONNECTED state (identically the RRC connection state), the network recognizes that the UE is being provided with service. If the UE is in the ECM-IDLE state (identically the RRC idle state), however, the situation of the UE is not valid in an eNB, but is stored in the MME. In such a case, only the MME is informed of the location of the UE in the ECM-IDLE state through the granularity of the list of Tracking Areas (TAs). A single TA is identified by a Tracking Area Identity (TAI) formed of the identifier of a PLMN to which the TA belongs and Tracking Area Code (TAC) that uniquely expresses the TA within the PLMN.

Thereafter, the UE selects a cell that belongs to cells provided by the selected PLMN and that has signal quality and characteristics on which the UE is able to be provided with proper service.

The following is a detailed description of a procedure of selecting a cell by a terminal.

When power is turned-on or the terminal is located in a cell, the terminal performs procedures for receiving a service by selecting/reselecting a suitable quality cell.

A terminal in an RRC idle state should prepare to receive a service through the cell by always selecting a suitable quality cell. For example, a terminal where power is turned-on just before should select the suitable quality cell to be registered in a network. If the terminal in an RRC connection state enters in an RRC idle state, the terminal should selects a cell for stay in the RRC idle state. In this way, a procedure of selecting a cell satisfying a certain condition by the terminal in order to be in a service idle state such as the RRC idle state refers to cell selection. Since the cell selection is performed in a state that a cell in the RRC idle state is not currently determined, it is important to select the cell as rapid as possible. Accordingly, if the cell provides a wireless signal quality of a predetermined level or greater, although the cell does not provide the best wireless signal quality, the cell may be selected during a cell selection procedure of the terminal.

A method and a procedure of selecting a cell by a terminal in a 3GPP LTE is described with reference to 3GPP TS 36.304 V8.5.0 (2009-03) “User Equipment (UE) procedures in idle mode (Release 8)”.

A cell selection process is basically divided into two types.

The first is an initial cell selection process. In this process, UE does not have preliminary information about a wireless channel. Accordingly, the UE searches for all wireless channels in order to find out a proper cell. The UE searches for the strongest cell in each channel. Thereafter, if the UE has only to search for a suitable cell that satisfies a cell selection criterion, the UE selects the corresponding cell.

Next, the UE may select the cell using stored information or using information broadcasted by the cell. Accordingly, cell selection may be fast compared to an initial cell selection process. If the UE has only to search for a cell that satisfies the cell selection criterion, the UE selects the corresponding cell. If a suitable cell that satisfies the cell selection criterion is not retrieved though such a process, the UE performs an initial cell selection process.

A cell selection criterion may be defined as in Equation 1 below.

Srxlev>0 AND Squal>0, [Equation 1]

where:

Srxlev=Qᵣₓₗₑᵥₘₑₐₛ−(Qᵣₓₗₑᵥₘᵢₙ+Q_{rxlevminoffset})−P_{compensation},

Squal=Q_{qualmeas}−(Q_{qualmin}+Q_{qualminoffset})

In this case, in Equation 1, the variables may be defined as in Table 1 below.

TABLE 1

| | |
|---|---|
| Srxlev | Cell selection RX level value (dB) |
| Squal | Cell selection quality value (dB) |
| Qᵣₓₗₑᵥₘₑₐₛ | Measured cell RX level value (RSRP) |
| Q_{qualmeas} | Measured cell quality value (RSRQ) |
| Qᵣₓₗₑᵥₘᵢₙ | Minimum required RX level in the cell (dBm) |
| Q_{qualmin} | Minimum required quality level in the cell (dB) |
| Q_{rxlevminoffset} | Offset to the signalled Qᵣₓₗₑᵥₘᵢₙ taken into account in the |
| | Srxlev evaluation as a result of a periodic search for a |
| | higher priority PLMN while camped normally in a |
| | VPLMN |
| Q_{qualminoffset} | Offset to the signalled Q_{qualmin} taken into account in the |
| | Squal evaluation as a result of a periodic search for a |
| | higher priority PLMN while camped normally in a |
| | VPLMN |
| Pcompensation | max(P_{EMAX} − P_{PowerClass}, 0) (dB) |
| P_{EMAX} | Maximum TX power level an UE may use when |
| | transmitting on the uplink in the cell (dBm) defined as |
| | P_{EMAX} in [TS 36.101] |
| P_{PowerClass} | Maximum RF output power of the UE (dBm) according |
| | to the UE power class as defined in [TS 36.101] |

Q_{rxlevminoffset} and Q_{qualminoffset}, that is, signaled values, are the results of periodic discovery for a PLMN having higher priority while UE camps on a normal cell within a VPLMN, and may be applied only when cell selection is evaluated. As described above, during the periodic discovery of a PLMN having higher priority, UE may perform cell selection evaluation using parameter values stored from another cell of the PLMN having such higher priority.

After UE selects any cell through a cell selection process, the intensity or quality of a signal between the UE and a BS may be changed due to the mobility of the UE or a change of a radio environment. Accordingly, if the quality of the selected cell is changed, the UE may select another cell providing better quality.

After the UE selects a specific cell through the cell selection process, the intensity or quality of a signal between the UE and a BS may be changed due to a change in the mobility or wireless environment of the UE. Accordingly, if the quality of the selected cell is deteriorated, the UE may select another cell that provides better quality. If a cell is reselected as described above, the UE selects a cell that provides better signal quality than the currently selected cell. Such a process is called cell reselection. In general, a basic object of the cell reselection process is to select a cell that provides UE with the best quality from a viewpoint of the quality of a radio signal.

In addition to the viewpoint of the quality of a radio signal, a network may determine priority corresponding to each frequency, and may inform the UE of the determined priorities. The UE that has received the priorities preferentially takes into consideration the priorities in a cell reselection process compared to a radio signal quality criterion.

As described above, there is a method of selecting or reselecting a cell according to the signal characteristics of a wireless environment. In selecting a cell for reselection when a cell is reselected, the following cell reselection methods may be present according to the RAT and frequency characteristics of the cell.
Intra-frequency cell reselection: UE reselects a cell having the same center frequency as that of RAT, such as a cell on which the UE camps on.
Inter-frequency cell reselection: UE reselects a cell having a different center frequency from that of RAT, such as a cell on which the UE camps on
Inter-RAT cell reselection: UE reselects a cell that uses RAT different from RAT on which the UE camps

The principle of a cell reselection process is as follows.

First, UE measures the quality of a serving cell and neighbor cells for cell reselection.

Second, cell reselection is performed based on a cell reselection criterion. The cell reselection criterion has the following characteristics in relation to the measurements of a serving cell and neighbor cells.

Intra-frequency cell reselection is basically based on ranking. Ranking is a task for defining a criterion value for evaluating cell reselection and numbering cells using criterion values according to the size of the criterion values. A cell having the best criterion is commonly called the best-ranked cell. The cell criterion value is based on the value of a corresponding cell measured by UE, and may be a value to which a frequency offset or cell offset has been applied, if necessary.

Inter-frequency cell reselection is based on frequency priority provided by a network. UE attempts to camp on a frequency having the highest frequency priority. A network may provide frequency priority that will be applied by UEs within a cell in common through broadcasting signaling, or may provide frequency-specific priority to each UE through UE-dedicated signaling. A cell reselection priority provided through broadcast signaling may refer to a common priority. A cell reselection priority for each terminal set by a network may refer to a dedicated priority. If receiving the dedicated priority, the terminal may receive a valid time associated with the dedicated priority together. If receiving the dedicated priority, the terminal starts a validity timer set as the received valid time together therewith. While the valid timer is operated, the terminal applies the dedicated priority in the RRC idle mode. If the valid timer is expired, the terminal discards the dedicated priority and again applies the common priority.

For the inter-frequency cell reselection, a network may provide UE with a parameter (e.g., a frequency-specific offset) used in cell reselection for each frequency.

For the intra-frequency cell reselection or the inter-frequency cell reselection, a network may provide UE with a Neighboring Cell List (NCL) used in cell reselection. The NCL includes a cell-specific parameter (e.g., a cell-specific offset) used in cell reselection.

For the intra-frequency or inter-frequency cell reselection, a network may provide UE with a cell reselection black list used in cell reselection. The UE does not perform cell reselection on a cell included in the black list.

Ranking performed in a cell reselection evaluation process is described below.

A ranking criterion used to give the priority of a cell is defined as in Equation 2.

Rₛ=Q_{meas,s}+Q_{hyst}, Rₙ=Q_{meas,n}−Q_{offset} [Equation 2]

In Equation 2, Rₛ is the ranking criterion of a serving cell on which UE now camps, Rₙ is the ranking criterion of a neighboring cell, Q_{meas,s} is the quality value of the serving cell measured by the UE, Q_{meas,n} is the quality value of the neighboring cell measured by the UE, Q_{hyst} is a hysteresis value for ranking, and Q_{offset} is an offset between the two cells.

In Intra-frequency, if UE receives an offset “Qoffsets,n” between a serving cell and a neighbor cell, Qoffset=Qoffsets,n. If UE does not Qoffsets,n, Qoffset=0.

In Inter-frequency, if UE receives an offset “Qoffsets,n” for a corresponding cell, Qoffset=Qoffsets,n+Qfrequency. If UE does not receive “Qoffsets,n”, Qoffset=Qfrequency.

If the ranking criterion Rs of a serving cell and the ranking criterion Rn of a neighbor cell are changed in a similar state, ranking priority is frequency changed as a result of the change, and UE may alternately reselect the twos. Qhyst is a parameter that gives hysteresis to cell reselection so that UE is prevented from to alternately reselecting two cells.

UE measures RS of a serving cell and Rn of a neighbor cell according to the above equation, considers a cell having the greatest ranking criterion value to be the best-ranked cell, and reselects the cell.

In accordance with the criterion, it may be checked that the quality of a cell is the most important criterion in cell reselection. If a reselected cell is not a suitable cell, UE excludes a corresponding frequency or a corresponding cell from the subject of cell reselection.

According to cell reselection evaluation, the terminal may determine that a cell reselection criterion is satisfied when the cell reselection criterion is satisfied for a specific time in performing cell reselection and may cell-move to a selected target cell. Herein, the specific time as a Treselection parameter may be given from the network. Treselection may specify a cell reselection timer value and be defined with respect to each frequency of E-UTRAN and another RAT.

Hereinafter, cell reselection information used for the cell reselection by the terminal will be described.

The cell reselection information may be transmitted while being included in system information broadcasted from the network and provided to the terminal in a format of a cell reselection parameter. The cell reselection parameter provided to the terminal may include types given below.

Cell reselection priority (cellReselectionPriority): The cellReselectionPriority parameter specifies priorities for a frequency of E-UTRAN, a frequency of UTRAN, a group of GERAN frequencies, a band class of CDMA2000 HRPD, or a band class of CDMA2000 1×RTT.

Qoffset_{s,n}: specifies an offset value between two cells.

Qoffset_{frequency}: specifies a frequency specific offset for the E-UTRAN frequency having the same priority.

Q_{hyst}: specifies a hysteresis value for a rank index.

Q_{qualmin}: specifies a minimally required quality level and is specified by the unit of dB.

Qᵣₓₗₑᵥₘᵢₙ: specifies a minimally required Rx level and is specified by the unit of dB.

Treselection_{EUTRA}: specifies a cell reselection timer value for E-UTRAN and may be set with respect to each frequency of E-UTRAN.

Treselection_{UTRAN}: specifies the cell reselection timer value for UTRAN.

Treselection_{GERA}: specifies the cell reselection timer value for GERAN.

Treselection_{CDMA}_{_}_{HRPD}: specifies the cell reselection timer value for CDMA HRPD.

Treselection_{CDMA}_{_}_{1×RTT}: specifies the cell reselection timer value for CDMA 1×RTT.

Thresh_{x, HighP}: specifies an Srxlev threshold used by the terminal during cell reselection with a RAT/frequency having a higher priority than a serving frequency by the unit of dB. The specific threshold may be individually set with respect to the frequency of each of E-UTRAN and UTRAN, each group of the GERAN frequency, each band class of CDMA2000 HRPD, and each band class CDMA2000 1×RTT.

Thresh_{x, HighQ}: specifies an Squal threshold used by the terminal during cell reselection with the RAT/frequency having the higher priority than the serving frequency by the unit of dB. The specific threshold may be individually set with respect to the frequency of each of E-UTRAN and UTRAN FDD.

Thresh_{x, LowP}: specifies the Srxlev threshold used by the terminal during cell reselection with a RAT/frequency having a lower priority than the serving frequency by the unit of dB. The specific threshold may be individually set with respect to the frequency of each of E-UTRAN and UTRAN, each group of the GERAN frequency, each band class of CDMA2000 HRPD, and each band class CDMA2000 1×RTT.

Thresh_{x, LowQ}: specifies the Squal threshold used by the terminal during cell reselection with a RAT/frequency having the lower priority than the serving frequency by the unit of dB. The specific threshold may be individually set with respect to the frequency of each of E-UTRAN and UTRAN FDD.

Thresh_{Serving, LowP}: specifies the Srxlev threshold used by the terminal on a serving cell during cell reselection with the RAT/frequency having the lower priority by the unit of dB.

Thresh_{Serving, LowQ}: specifies the Squal threshold used by the terminal on the serving cell during cell reselection with the RAT/frequency having the lower priority by the unit of dB.

S_{IntraSerachP}: specifies the Srxlev threshold for intra-frequency measurement by the unit of dB.

S_{IntraSerachQ}: specifies the Squal threshold for the intra-frequency measurement by the unit of dB.

S_{nonIntraSerachP}: specifies the Srxlev threshold for E-UTRAN inter-frequency and inter-RAT measurement by the unit of dB.

S_{nonIntraserachQ}: specifies the Squal threshold for the E-UTRAN inter-frequency and inter-RAT measurement by the unit of dB.

Meanwhile, the cell reselection information may be provided to the terminal while being included in an RRC connection release message which is an RRC message transmitted for RRC connection release between the network and the terminal. For example, the RRC connection release message may include a subcarrier frequency list and a cell reselection priority of E-UTRAN, a subcarrier frequency list and a cell reselection priority of UTRA-FDD, a subcarrier frequency list and a cell reselection priority of UTRA-TDD, a subcarrier frequency list and a cell reselection priority of GERAN, a band class list and a cell reselection priority of CDMA2000 HRPD, a band class list and a cell reselection priority of CDMA2000 1×RTT, and the like.

In what follows, described will be RAN sharing among a plurality of service providers.

A plurality of service providers may provide a service to subscribers by constructing an RAN individually but by sharing a cell constructed by a particular service provider. The latter case is called RAN sharing. At this time, a cell shared among a plurality of service providers can broadcast a PLMN list. A PLMN list can be transmitted being included in the SIB1 of the system information broadcast by a cell. Meanwhile, the PLMN identifier listed in the first place of the PLMN list included in the SIB1 can be made to indicate the primary PLMN.

While one cell is being shared among a plurality of service providers, the cell reselection information that the shared cell provides can be applied commonly to all of the PLMNs within the PLMN list. In general, cell reselection information that a shared cell provides is configured to accord primarily with the policy of the primary PLMN. Therefore, those UEs receiving a service from the secondary PLMN perform cell reselection on the basis of the information other than the cell reselection information optimized for providing the service.

In what follows, described will be handover related to movement of a UE in the RRC connected state.

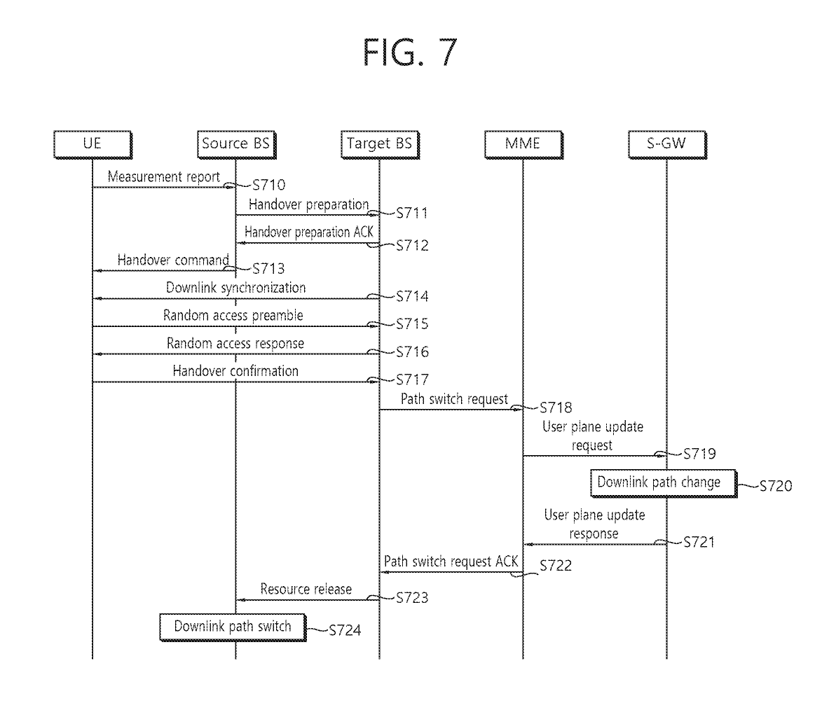

FIG. 7 is a flow diagram illustrating a handover procedure.

A UE transmits a measurement report to a source BS S710. The source BS determines whether to perform handover on the basis of the received measurement report. In case the source BS determines handover to a neighboring cell, the neighboring cell becomes a target cell, and a BS belonging to the target cell becomes a target BS.

The source BS transmits a handover preparation message to the target BS S711. The target BS performs admission control to increase the success rate of handover.

The target BS transmits a handover preparation ACK (Acknowledgement) message to the source BS S712. The handover preparation ACK message can include a C-RNTI (Cell-Radio Network Temporary Identifier) and/or a dedicated random access preamble. The C-RNTI is an identifier for identifying a UE within a cell. The dedicated random access preamble is such a preamble that a UE can use exclusively for a predetermined time period and is used when a non-contention based random access process is performed. Random access processes are divided into contention-based random access processes where a UE employs an arbitrary random access preamble and non-contention based random access processes where a UE employs a dedicated random access preamble. A non-contention based random access process can prevent a handover delay due to contention with other UEs commonly observed in a contention-based random access process.

The source BS transmits a handover command message to the UE 5713. The handover command message can be transmitted in the form of an RRC (Radio Resource Control) connection reconfiguration message. The handover command message can include a C-RNTI received from the target BS and a dedicated random access preamble.

After receiving the handover command message from the source BS, the UE synchronizes itself with the target BS 5714. The UE synchronizes with the target BS by receiving a PSS and SSS of the target BS; and obtains system information by receiving a PBCH.

The UE initiates a random access process by transmitting a random access preamble to the target BS 5715. The UE can employ the dedicated random access preamble included in the handover command message. Or if the dedicated random access preamble has not been allocated, the UE can use a random access preamble selected arbitrarily from a set of random access preambles.

The target BS transmits a random access response message to the UE 5716. The random access response message can include uplink resource allocation and/or timing advance.

The UE which has received the random access response message adjusts uplink synchronization timing on the basis of the timing advance and transmits a handover confirm message to the target BS by using resource allocation 5717. The handover confirm message indicates that the handover process has been completed and can be transmitted together with an uplink buffer status report.

By transmitting a path switch request message to an MME (Mobility Management Entity), the target BS notifies the MME that the cell of the UE has been changed S718.

The MME transmits a user plane update request message to an S-GW (Serving-Gateway) S719.

The S-GW switches a downlink data path to the target BS S720.

The S-GW transmits a user plane update response message to the MME S721.

The MME transmits a path switch request ACK message to the target BS S722.

The target BS informs the source BS of success of the handover by transmitting a resource release message S723.

The source BS releases resources related to the UE S724.

Hereinafter, radio link monitoring (RLM) will be described.

UE monitors downlink quality on the basis of a cell-specific reference signal in order to detect downlink radio link quality of a PCell. The UE estimates the downlink radio link quality and compares the estimated downlink radio link quality with thresholds Qout and Qin in order to monitor the downlink radio link quality of the Pcell. The threshold Qout is defined as a level of the downlink radio link quality which may not be stably received, and corresponds to a block error rate of 10% of hypothetical PDCCH transmission by considering a PDFICH error. The threshold Qin is defined a level of the downlink radio link quality which may be more stably received than the level of Qout and corresponds to a block error rate of 2% of the hypothetical PDCCH transmission by considering the PDFICH error.

Hereinafter, radio link failure (RLF) will be described.

UE continues to perform measurements in order to maintain the quality of a radio link with a serving cell from which the UE receives service. The UE determines whether or not communication is impossible in a current situation due to the deterioration of the quality of the radio link with the serving cell. If communication is almost impossible because the quality of the serving cell is too low, the UE determines the current situation to be an RLF.

If the RLF is determined, the UE abandons maintaining communication with the current serving cell, selects a new cell through cell selection (or cell reselection) procedure, and attempts RRC connection re-establishment with the new cell.

In the specification of 3GPP LTE, the following examples are taken as cases where normal communication is impossible.
A case where UE determines that there is a serious problem in the quality of a downlink communication link (a case where the quality of a PCell is determined to be low while performing RLM) based on the radio quality measured results of the PHY layer of the UE
A case where uplink transmission is problematic because a random access procedure continues to fail in the MAC sublayer.
A case where uplink transmission is problematic because uplink data transmission continues to fail in the RLC sublayer.
A case where handover is determined to have failed.
A case where a message received by UE does not pass through an integrity check.

An RRC connection re-establishment procedure is described in more detail below.

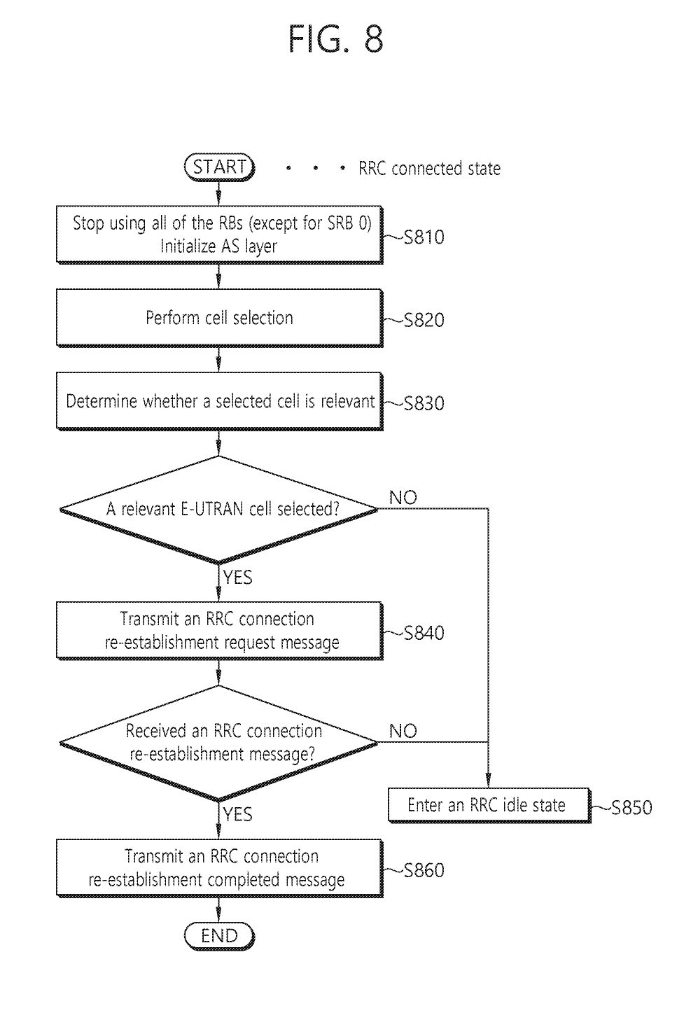

FIG. 8 is a diagram illustrating an RRC connection re-establishment procedure.

Referring to FIG. 8, UE stops using all the radio bearers that have been configured other than a Signaling Radio Bearer (SRB) #0, and initializes a variety of kinds of sublayers of an Access Stratum (AS) (S810). Furthermore, the UE configures each sublayer and the PHY layer as a default configuration. In this process, the UE maintains the RRC connection state.

The UE performs a cell selection procedure for performing an RRC connection reconfiguration procedure (S820). The cell selection procedure of the RRC connection re-establishment procedure may be performed in the same manner as the cell selection procedure that is performed by the UE in the RRC idle state, although the UE maintains the RRC connection state.

After performing the cell selection procedure, the UE determines whether or not a corresponding cell is a suitable cell by checking the system information of the corresponding cell (S830). If the selected cell is determined to be a suitable E-UTRAN cell, the UE sends an RRC connection re-establishment request message to the corresponding cell (S840).

Meanwhile, if the selected cell is determined to be a cell that uses RAT different from that of the E-UTRAN through the cell selection procedure for performing the RRC connection re-establishment procedure, the UE stops the RRC connection re-establishment procedure and enters the RRC idle state (S850).

The UE may be implemented to finish checking whether the selected cell is a suitable cell through the cell selection procedure and the reception of the system information of the selected cell. To this end, the UE may drive a timer when the RRC connection re-establishment procedure is started. The timer may be stopped if it is determined that the UE has selected a suitable cell. If the timer expires, the UE may consider that the RRC connection re-establishment procedure has failed, and may enter the RRC idle state. Such a timer is hereinafter called an RLF timer. In LTE spec TS 36.331, a timer named “T311” may be used as an RLF timer. The UE may obtain the set value of the timer from the system information of the serving cell.

If an RRC connection re-establishment request message is received from the UE and the request is accepted, a cell sends an RRC connection re-establishment message to the UE.

The UE that has received the RRC connection re-establishment message from the cell reconfigures a PDCP sublayer and an RLC sublayer with an SRB1. Furthermore, the UE calculates various key values related to security setting, and reconfigures a PDCP sublayer responsible for security as the newly calculated security key values. Accordingly, the SRB1 between the UE and the cell is open, and the UE and the cell may exchange RRC control messages. The UE completes the restart of the SRB1, and sends an RRC connection re-establishment complete message indicative of that the RRC connection re-establishment procedure has been completed to the cell (S860).

In contrast, if the RRC connection re-establishment request message is received from the UE and the request is not accepted, the cell sends an RRC connection re-establishment reject message to the UE.

If the RRC connection re-establishment procedure is successfully performed, the cell and the UE perform an RRC connection reconfiguration procedure. Accordingly, the UE recovers the state prior to the execution of the RRC connection re-establishment procedure, and the continuity of service is guaranteed to the upmost.

In what follows, measurement and a measurement report will be described.

In a mobile communication system, mobility support of a UE is essential. Therefore, a UE measures quality of a service cell which provides a current service and quality of a neighboring cell continuously. The UE reports a measurement result to the network at appropriate timing, and the network provides optimal mobility to the UE through handover. Often measurement to this purpose is called RPM (Radio Resource Management) measurement.

In addition to mobility support, to provide information useful for a service provider to operate the network, the UE can perform measurement to attain a specific objective set by the network and report the measurement result to the network. For example, the UE receives broadcast information of a specific cell specified by the network. The UE can report to a serving cell on a cell identifier of the specific cell (which is also called a global cell identifier), position identification information of the specific cell (for example, tracking area code) and/or miscellaneous cell information (for example, membership of a CSG (Closed Subscriber Group) cell).

In case a UE in movement realizes service quality of a particular area is quite low, the UE can report to the network on the position information and measurement results about those cells with poor quality. The network can attempt optimization of the network on the basis of the measurement reports from the UEs supporting operation of the network.

For a mobile communication system of which the frequency reuse factor is 1, mobility is usually supported among different cells but belonging to the same frequency band. Therefore, to ensure mobility of a UE, the UE has to measure with a good degree of accuracy qualities of neighboring cells having the same center frequency as that of a serving cell and information of the cells. Measurement of a cell having the same center frequency as that of the serving cell is called intra-frequency measurement. Performing intra-frequency measurement and reporting the measurement result to the network at appropriate timing, the UE contributes to achieve the objective of the corresponding measurement result.

A mobile communication service provider may operate the network by using a plurality of frequency bands. In case a service of a communication system is provided through a plurality of frequency bands, to ensure optimal mobility, a UE has to measure with a good degree of accuracy qualities of neighboring cells having a center frequency different from that of a serving cell and information of the cells. In this way, measurement of a cell having a center frequency different from that of a serving cell is called inter-frequency measurement. The UE should be able to perform inter-frequency measurement and report the measurement result to the network at appropriate timing.

In case a UE supports measurement about a network based on a different RAT, the UE may perform measurement of a cell belonging to the corresponding network by utilizing BS configuration. This kind of measurement is called inter-RAT (Radio Access Technology) measurement. For example, RAT can include UTRAN (UMTS Terrestrial Radio Access Network) compliant with the 3GPP standard specifications and GERAN (GSM EDGE Radio Access Network), as well as the CDMA 2000 system compliant with the 3GPP2 standard specifications.

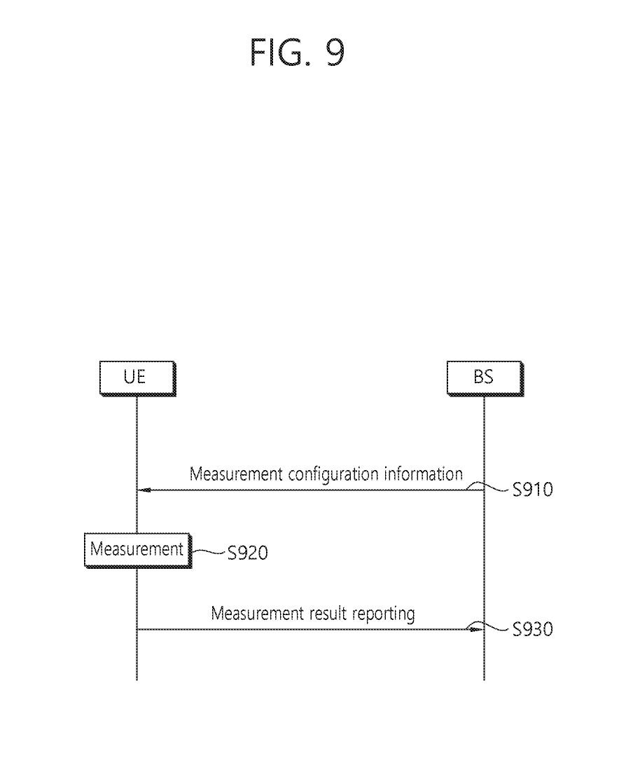

FIG. 9 is a flow diagram illustrating a conventional method for performing measurement.

The UE receives measurement configuration information from the BS S910. A message including measurement configuration information is called a measurement configuration message. The UE performs measurement on the basis of the measurement configuration information S920. If the measurement result satisfies a report condition within the measurement configuration information, the UE report to the BS on the measurement result S930. A message including a measurement result is called a measurement report message.

The measurement configuration information can include the following information.

(1) Measurement object information: information about an object about which the UE performs measurement. A measurement object includes at least one of an intra-frequency measurement object which is an object of intra-cell measurement, an inter-frequency measurement object which is an object of inter-cell measurement, and an inter-RAT measurement object which is an object of inter-RAT measurement. For example, an intra-frequency measurement object can specify a neighboring cell having the same frequency band as that of a serving cell, an inter-frequency measurement object can specify a neighboring cell having a frequency band different from that of the serving cell, and an inter-RAT measurement object can specify a neighboring cell employing RAT different from that of the serving cell.

(2) Reporting configuration information: information about a reporting condition specifying when a UE reports transmission of a measurement result and report type. The reporting configuration information can comprise a list of reporting configurations. Each reporting configuration can include a reporting criterion and a reporting format. The reporting criterion is a criterion by which a UE is triggered to transmit a measurement result. The reporting criterion can be a measurement reporting period or a single event for measurement reporting. The reporting format specifies in which type a UE organizes a measurement result.

(3) Measurement identity information: information about a measurement identifier used for a UE to determine which measurement object to report at which time and in which type by associating a measurement object with a reporting configuration. The measurement identity information, being included in a measurement reporting message, can indicate which measurement object a measurement result describes and from which reporting condition a measurement report has been made.

(4) Quantity configuration information: information about parameters to configure a measurement unit, reporting unit and/or filtering of a measurement result.

(5) Measurement gap information: information about a measurement gap a dedicated period for which a UE performs measurement only without considering data transmission to and from a serving cell as downlink or uplink transmission is not scheduled in that period.

To perform a measurement procedure, the UE has a measurement object list, measurement reporting confirmation list, and measurement identifier list.

In the 3GPP LTE, a base station can configure only one measurement object with respect to one frequency band for the UE. The Clause 5.5.4 of the 3GPP TS 36.331 V8.5.0 (2009-03) “Evolved Universal Terrestrial Radio Access (E-UTRA) Radio Resource Control (RRC); Protocol specification (Release 8)” defines events which cause measurement reporting as shown in the following table.

TABLE 2

| Event | Reporting condition |
|---|---|
| Event A1 | Serving becomes better than threshold |
| Event A2 | Serving becomes worse than threshold |
| Event A3 | Neighbour becomes offset better than serving |
| Event A4 | Neighbour becomes better than threshold |
| Event A5 | Serving becomes worse than thresholdl and |
| | neighbour becomes better than threshold2 |
| Event B1 | Inter RAT neighbour becomes better than threshold |
| Event B2 | Serving becomes worse than thresholdl and inter |
| | RAT neighbour becomes better than threshold2 |

If a measurement result satisfies a configured event, the UE transmits a measurement reporting message to the base station.

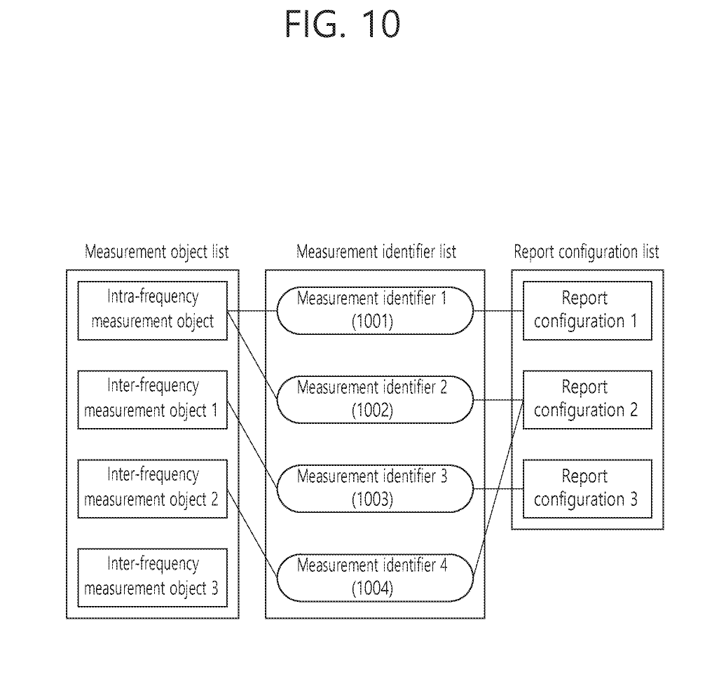

FIG. 10 illustrates one example of measurement configuration applied to a UE.

First, a measurement identifier 1 1001 connects an intra-frequency measurement object to reporting configuration 1. The UE performs intra-frequency measurement, and reporting configuration 1 is used to determine a measurement result reporting criterion and a reporting type.

A measurement identifier 2 1002, being connected to an intra-frequency measurement object in the same way as the measurement identifier 1 1001, connects the intra-frequency measurement object to reporting configuration 2. The UE performs measurement, and the reporting configuration 2 is used to determine a measurement result reporting criterion and a reporting type.

Due to the measurement identifier 1 1001 and the measurement identifier 2 1002, the UE transmits a measurement result even if a measurement result about the intra-frequency measurement object satisfies either of the reporting configuration 1 and the reporting configuration 2.

A measurement identifier 3 1003 connects an inter-frequency measurement object 1 to reporting configuration 3. The UE reports a measurement result if the measurement result about the inter-frequency measurement object 1 satisfies a reporting condition included in the reporting configuration 1.

A measurement identifier 4 1004 connects an inter-frequency measurement object 2 to reporting configuration 2. The UE reports a measurement result if the measurement result about the inter-frequency measurement object 2 satisfies a reporting condition included in the reporting configuration 2.

Meanwhile, a measurement object, reporting configuration and/or measurement identifier can be added, modified and/or deleted. The aforementioned operation can be specified as a base station sends a new measurement configuration message or measurement configuration change message to the UE.

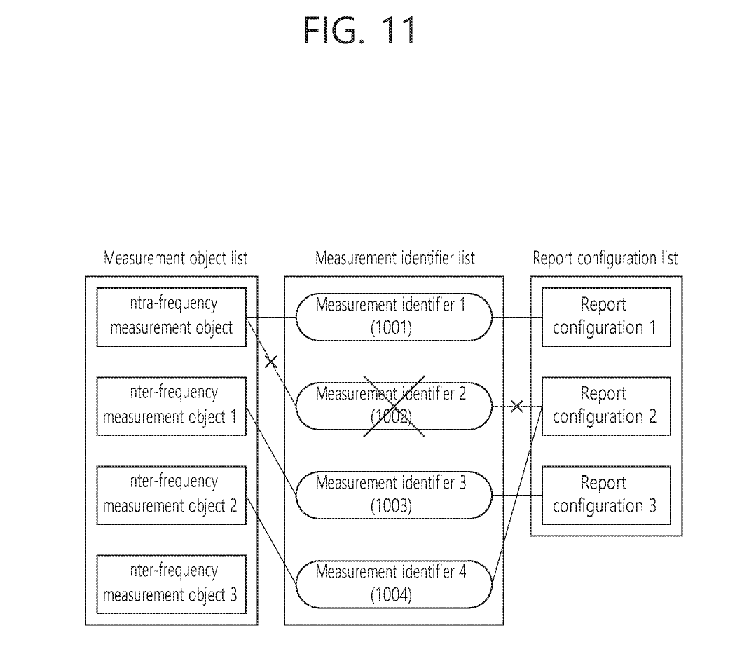

FIG. 11 illustrates an example of deleting a measurement identifier. If the measurement identifier 2 1002 is deleted, measurement about an object related to the measurement identifier 2 1002 is stopped, and a measurement report is not transmitted, either. A measurement object related to the deleted measurement identifier or reporting configuration may not be changed.

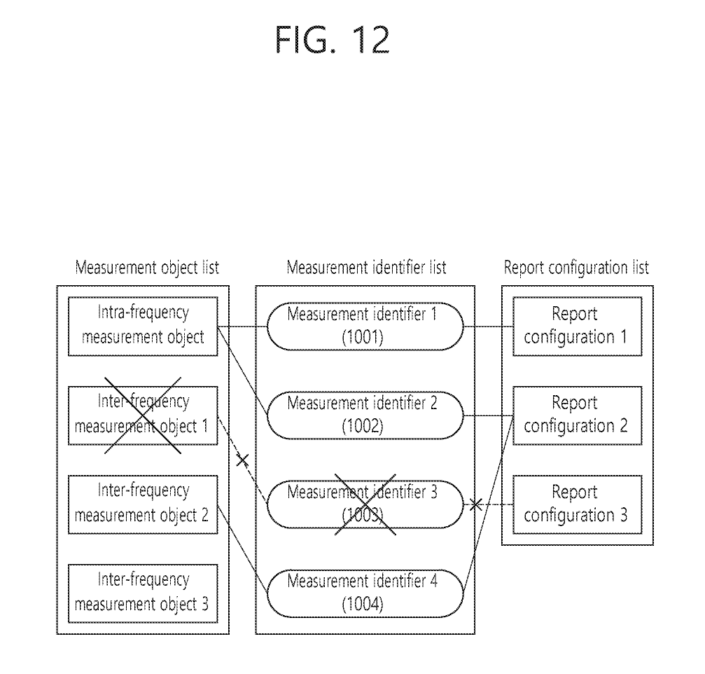

FIG. 12 illustrates an example of deleting a measurement object. If the inter-frequency measurement object 1 is deleted, the UE also deletes the associated measurement identifier 3 1003. Measurement about the inter-frequency measurement object 1 is stopped, and a measurement report is not transmitted, either. However, reporting configuration related to the deleted inter-frequency measurement object 1 may not be modified or deleted.

If reporting configuration is deleted, the UE also deletes the associated measurement identifier. The UE stops measuring the measurement object associated by the associated measurement identifier. However, the measurement object associated to the deleted reporting configuration may not be modified or deleted.

A measurement report can include a measurement identifier, measured quality of a serving cell, and a measurement result of a neighboring cell. A measurement identifier is used to identify a measurement object for which measurement reporting has been triggered. The measurement result of a neighboring cell can include a cell identifier and measured quality of the neighboring cell. The measured quality can include at least one of RSRP (Reference Signal Received Power) and RSRQ (Reference Signal Received Quality).

In what follows, described will be operation of a UE and a network related to RRC connection refusal.

If a UE does not receive a normal service at a specific frequency and/or specific RAT due to a situation such as congestion of a communication environment, the network can be configured to apply the lowest priority for cell reselection to the corresponding frequency and/or over the whole frequency range of the corresponding RAT.

Application of the lowest priority set up by the network influences the RRC connection establishment procedure of the UE. The UE in the RRC idle state selects a target cell through a cell selection process and attempts to establish an RRC connection to the corresponding cell. The target cell can reject an RRC connection request received from the UE on the reason that the target cell is unable to provide a normal service to the UE due to congestion, according to which the target cell can transmit an RRC connection rejection message to the UE.

The target cell can include the lowest priority request information in the RRC connection rejection message, which commands the UE to apply the lowest priority to the corresponding frequency and/or over the whole frequency range of the corresponding RAT in performing cell reselection. The lowest priority request information can include lowest priority type information which specifies the type to which the lowest priority is applied and lowest priority timer information which specifies a duration of the lowest priority. The lowest priority type information can be configured to indicate applying the lowest priority to the frequency of a cell which has transmitted the RRC connection rejection message or to indicate applying the lowest priority over the whole frequency range of the RAT of the corresponding cell.

Receiving the RRC connection rejection message including the lowest priority request information, the UE can initiate a timer configured to the lowest priority application duration and perform cell reselection by applying the lowest priority to the object specified by the lowest priority type information.

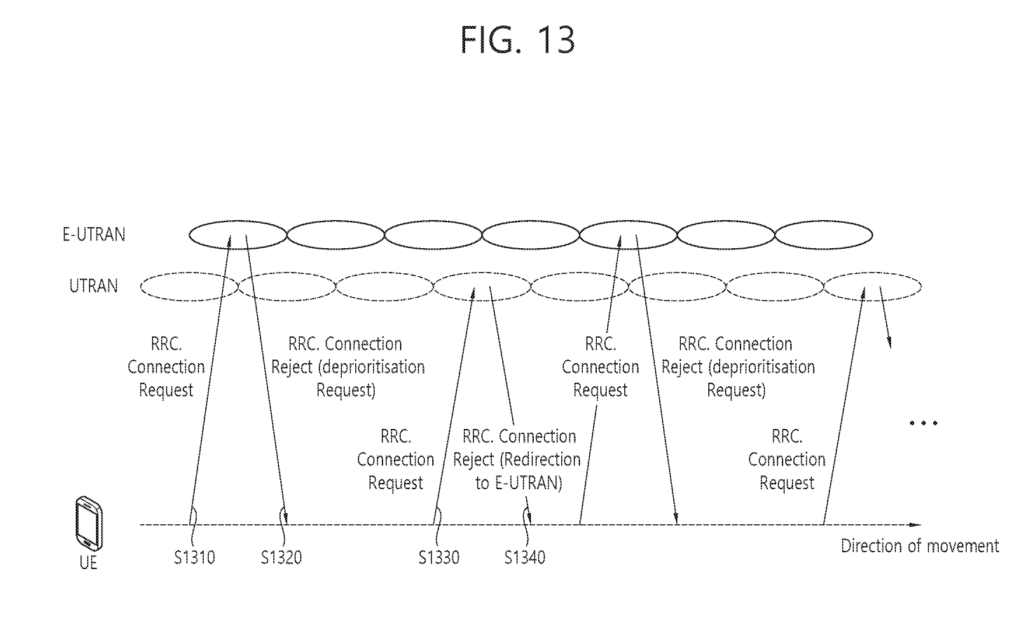

As described above, in case a network is operated as being configured to apply the lowest priority, a particular network node may be aware of the situation where the network is configured to apply the lowest priority while other network node may not be aware of the situation. In this wireless communication environment, there can be a chance that a moving UE fails to select and approach a relevant cell to receive a service. Described will be a problem that can occur with reference to FIG. 13.

FIG. 13 illustrates an example problem that can occur due to a movement of a UE.

With reference to FIG. 13, LTE cells of the E-UTRAN are disposed on a network, together with UMTS cells of the UTRAN. It is assumed that a UE is moving in a specific direction. Also it is further assumed that the lowest priority is applied over the whole frequency range of the E-UTRAN due to the congestion thereof. It is still assumed that UMTS cells are not aware of the fact that the lowest priority is applied, while the cells of the E-UTRAN and the cells of the UTRAN are being uncoordinated with each other.

First of all, the UE can attempt to establish an RRC connection to an LTE cell. Accordingly the UE sends an RRC connection request message to the LTE cell S1310. Due to congestion, the LTE cell may not allow the UE to establish a connection, and accordingly the LTE cell can transmit an RRC connection rejection message to the UE S1320. The RRC connection rejection message can include lowest priority request information.

The UE can select an UMTS cell as a target cell through cell reselection and attempt to establish an RRC connection. Accordingly, the UE transmits an RRC connection request message to the UMTS cell S1330. Meanwhile, UMTS cells are capable of providing a service to the UE in a more efficient manner and move the UE to the LTE cell more preferred by the UE. Therefore, the UMTS cell can redirect the UE to an LTE cell without allowing the UE to perform connection establishment. Thus the UMTS cell can transmit an RRC connection rejection message to redirect the UE to the LTE cell S1340.

The UE of which the connection request has been rejected by the UMTS cell can perform cell reselection again to select an LTE cell. However, unless congestion of the E-UTRAN is solved, an LTE cell may continuously reject connection establishment requested by the UE. Also, the UMTS cell unaware of congestion of the E-UTRAN and/or application of the lowest priority to E-UTRAN frequencies may continuously reject connection establishment that the UE requests for redirection to the LTE cell. Therefore, there are chances that the UE fails to establish an RRC connection in both of the E-UTRAN and UTRAN and switches back and forth between the E-UTRAN and the UTRAN.

Besides the movement of a UE related to cell reselection described with reference to FIG. 13, movement of the UE related to handover may also cause a problem.

While the UE does not receive a normal service from a source cell and/or at frequencies of the source cell due to congestion of the source cell, the UE can move to a target cell through handover. Meanwhile, in case the target cell is not aware of the wireless communication environment of the source cell prior to the handover, the target cell configures the frequency of the previous source cell as a measurement object with respect to the UE. Therefore, the UE may perform an unnecessary operation such as performing measurement and reporting on the previous source cell to which the UE is in fact unable to move or on the corresponding frequency thereof. In this way, efficiency in terms of network operation may be degraded as radio resources are occupied by the unnecessary operation of the UE and/or network, leading to decrease of power efficiency of the UE.

To prevent the aforementioned problem and make the UE and the network operate in a more efficient manner, a method for a network node to provide mobility restriction information which includes lowest priority information to a different network node according to an embodiment of the present invention is proposed.

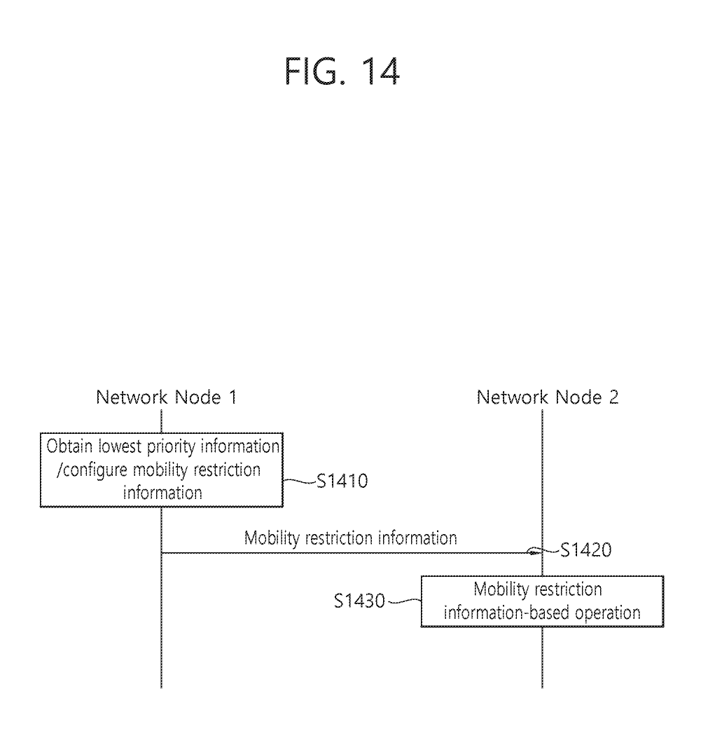

FIG. 14 illustrates a communication method based on mobility restriction information according to an embodiment of the present invention.

In a communication method based on mobility restriction information shown in FIG. 14, the network node 1 which provides mobility restriction information may be a UE or a base station. In case the network node 1 is a base station (BS), the BS can be eBN of the E-UTRAN or NodeB of the UTRAN. The network node 2 can be a BS. In other words, the mobility restriction information can be sent from a specific BS to another BS or from a UE to the BS.

With reference to FIG. 14, the network node 1 obtains lowest priority information and configures the mobility restriction information S1410. Obtaining and configuring the mobility restriction information can be implemented differently according to whether the network node 1 is a BS like eNB or NodeB, or whether the network node 1 is a UE.

1) In case the network node 1 is a BS

That the eNB or NodeB obtains the lowest priority information can include applying lowest priority to one or more frequencies and/or over the whole frequency range of a particular RAT and generating information related to the application. The lowest priority information can include a list of one or more frequencies and/or a list of RATs to which the lowest priority is applied or supposed to be applied. Likewise, the lowest priority information can include a list of one or more frequencies and/or a list of RATs to which the lowest priority is not applied. In another case, the lowest priority information can include both of the two types of lists.

The eNB or NodeB configures the mobility restriction information which includes the lowest priority information. In case a time period for which the eNB or NodeB applies the lowest priority is configured separately, the mobility restriction information can further include lowest priority duration information which indicates a time period for which the lowest priority is applied. Or the mobility restriction information can further include the lowest priority duration information which indicates a time period for which the eNB or NodeB is operated on the basis of the lowest priority information.

2) In case the network node 1 is a UE

That a UE obtains lowest priority information can include the UE's obtaining lowest priority request information from a BS. The UE can obtain the lowest priority request information by receiving an RRC connection rejection message including the lowest priority request information while performing the RRC connection establishment procedure. The lowest priority information can include a list of one or more frequencies and/or a list of RATs to which the lowest priority is applied or supposed to be applied. Likewise, the lowest priority information can include a list of one or more frequencies and/or a list of RATs to which the lowest priority is not applied. In another case, the lowest priority information can include both of the two types of lists.

The mobility restriction information can further include lowest priority duration information. In this case, the lowest priority duration information can be configured to indicate a time period for which the lowest priority is applied according to the configuration value of a lowest priority timer within the lowest priority request information received by the UE.

The UE configures the mobility restriction information which include the lowest priority information. In addition, the mobility restriction information can further include connection rejection information. The connection rejection information can include the information related to the UE's attempts for establishing a connection which have been rejected by the network. The connection rejection information can be implemented to include the information as shown below.

Rejected Connection Counter

A rejected connection counter can be configured to indicate the number of attempts that the UE has performed to establish a connection but rejected by the network. The number of rejections made against connection establishment attempts can be the number of rejections counted within a fixed time period or within a particular time period configured by the network. The number of rejections made against connection establishment attempts can be the number of rejections counted after an RRC connection to the network is released, namely the UE enters an RRC idle state. In case the network rejects connection establishment attempted by the UE, the rejected connection counter can be increased.

The rejected connection counter can be reset if establishment of an RRC connection to the network is allowed. For example, the rejected connection counter can be reset as the network allows an attempt made by the UE to establish a connection and the UE receives an RRC connection configuration message from the network.

Rejected Connection Timer

A rejected connection timer can be configured to indicate a time period since the UE's attempt to establish a connection is rejected.

The rejected connection timer can be initiated as the network rejects the UE's attempt for establishing a connection. In other words, if the UE receives an RRC connection rejection message from the network, the UE can initiate the rejected connection timer.

The rejected connection timer can be reset if establishment of an RRC connection to the network is allowed. For example, if the network allows the UE's attempt to establish a connection, and thus the UE receives an RRC connection configuration message from the network, the rejected connection timer can be reset.

Rejected Connection Tolerance Information

Rejected connection tolerance information can be configured to indicate whether rejecting the UE's attempt for establishing a connection can be further allowed. In case the UE's attempt to establish a connection is rejected continuously, the UE may not tolerate further connection rejection to receive a service, and to inform the network of the UE's intolerance to further rejections, rejected connection tolerance information can be provided to the network.

The rejected connection tolerance information can be determined on the basis of the aforementioned rejected connection counter and/or rejected connection timer. The rejected connection counter gives information about how many times the UE's attempt to establish a connection has been rejected, and the rejected connection timer gives information about a time period for which the UE fails to establish an RRC connection to the network; therefore, by using the two types of information, the UE can determine whether further rejection of an attempt for establishing a connection is possible or not. More specifically, in case the rejected connection counter exceeds a specific threshold value, the rejected connection tolerance information can be configured to indicate that further rejection of an attempt for establishing a connection will not be allowed. Similarly, in case the rejected connection timer exceeds a specific threshold value, the rejected connection tolerance information can be configured to indicate that further rejection of an attempt for establishing a connection will not be allowed.

Referring again to FIG. 14, the network node 1 transmits mobility restriction information to the network node 2 S1420.

In case the network node 1 is an eNB or NodeB, mobility restriction information can be transmitted to the network node 2 through X2 interface. The network node 1's transmitting the mobility restriction information to the network node 2 can be performed as the network node 1 is configured to apply the lowest priority. In other words, the mobility restriction information can be triggered automatically as the network node 1 is configured to apply the lowest priority without involving a request from a different network node. Also, the network node 1's transmitting the mobility restriction information to the network node 2 can be performed in response to the request of the network node 2.

In case the network node 1 is an eNB or NodeB, the mobility restriction information can be transmitted to the network node 2 while a handover procedure is being carried out. In this case, the mobility restriction information can be transmitted to the network node 2 being included in a handover preparation message through the X2 interface. In other words, while a source cell performs the handover preparation procedure between the network node 1 of the source cell and the network node 2 of a target cell, the source cell can transmit the mobility restriction information to the network node 2 by including the mobility restriction information in the handover preparation message.

In case the network node 1 is a UE, the mobility restriction information can be transmitted to the network node 2 while an RRC connection establishment procedure is being performed. For example, the mobility restriction information can be transmitted to the network node 2 by being included in an RRC connection establishment request message transmitted to request establishing an RRC connection or an RRC connection establishment end message which ends the RRC connection establishment procedure. Also, the mobility restriction information can be transmitted in response to the request of the network node 2.

Meanwhile, the UE can further include movement trigger information in the mobility restriction information. The movement trigger information can indicate which movement trigger has initiated the most recent movement of the UE. A movement trigger can indicate a triggering source which has caused a movement of the UE, such as redirection, cell reselection, configuration of the lowest priority, PLMN selection, handover, and MBMS service. Cell reselection as a movement trigger can be indicated either as cell reselection based on signaled priority or cell reselection based on the priority irrespective of the signaling.

The network node 2 which has received the mobility restriction information is operated on the basis of the received information S1430. The network node 2 can be operated so that the UE is prevented from being moved again to one or more frequencies or particular RAT related to the lowest priority information included in the mobility restriction information.

In case the network node 2 receives the mobility restriction information from the network node 1, the network node 2 can be configured so that establishment of an RRC connection of a moved UE is allowed from one or more frequencies and/or RAT to which the lowest priority is applied or supposed to be applied. For example, the UE may have transmitted pre-redirection information which indicates a preferred frequency and/or RAT to the network node 2 by including the pre-redirection information in the RRC connection request message, and the lowest priority can be applied or is being applied to the preferred frequency and/or RAT. In this case, the network node 2 may not reject an RRC connection request to prevent the UE from being redirected to the preferred frequency and/or RAT.

In case mobility restriction information is received from the network node 1 through a handover preparation message, the network node 2 can provide the UE with an RRC configuration to prevent a UE to be handed over from being redirected to one or more frequencies and/or RAT to which the lowest priority is applied or supposed to be applied. The RRC configuration can be provided to the UE during a handover procedure or after the handover procedure is completed. For example, the network node 2 can provide a measurement configuration to the UE, by which a UE which has established an RRC connection through handover excludes frequency and/or RAT to which the lowest priority is applied or supposed to be applied from among measurement objects.

Meanwhile, in case mobility restriction information includes lowest priority duration information, the network node 2 can be operated on the basis of the mobility restriction information during a time period indicated by the lowest priority duration information. In case the time period is completed, the network node 2 can perform such operation as establishing an RRC connection of a UE, RRC configuration, and handover without considering the mobility restriction information. Also, in case a time period due to the lowest priority duration information is completed, the network node 2 can discard received mobility restriction information.

In addition, the network node 1 can include lowest priority release information which indicates that application of the lowest priority has been released in generating the mobility restriction information. In case the network node 1 is a BS, the BS which has determined that network congestion has been solved and thus further application of the lowest priority with respect to a particular frequency or a particular RAT is not needed can stop application of the lowest priority and include the lowest priority release information in the mobility restriction information. In case the network node 1 is a UE, if the lowest priority timer is completed, the lowest priority release information can be included in the mobility restriction information.

The network node 2 which has received the lowest priority release information from the network node 1 can stop operation based on the mobility restriction information received previously. In case the network node 2 has received the lowest priority duration information beforehand and receives the lowest priority release information after the reception of the lowest priority duration information, whether to stop operation based on the mobility restriction information when the time period specified by the duration information is completed or whether to stop operation based on the mobility restriction information when the lowest priority release information is received can be determined according to how it is actually implemented.

In what follows, embodiments of the present invention will be described in more detail with reference to appended drawings.

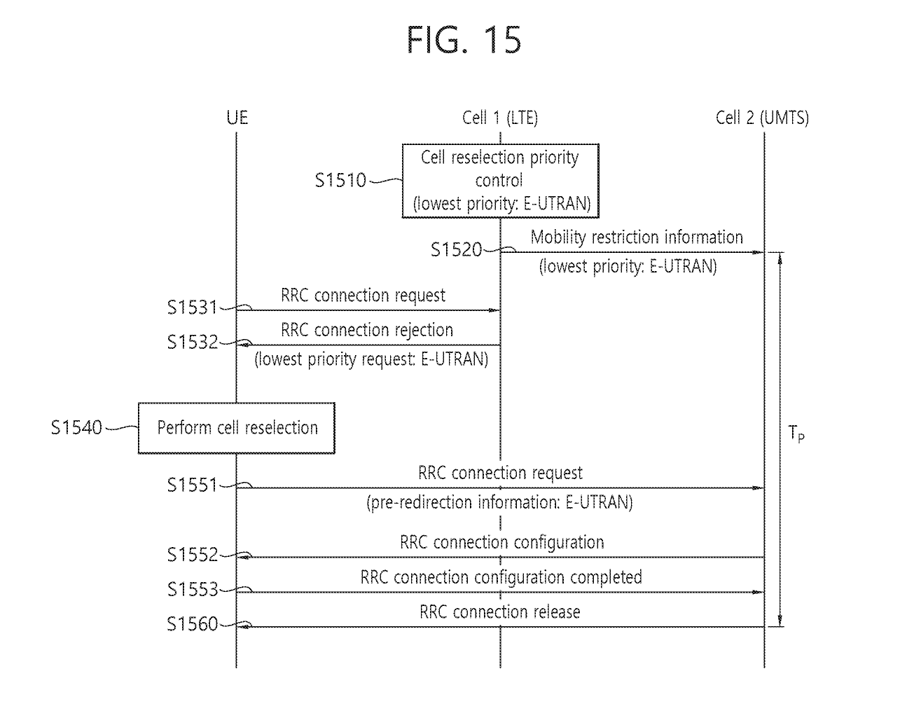

FIG. 15 illustrates one example of a communication method based on mobility restriction information according to an embodiment of the present invention.

In the example of FIG. 15, it is assumed that the UE is in an RRC idle state, cell 1 is an LTE cell, and cell 2 is an UMTS cell. Also, it is assumed that the cell 1 and the cell 2 are uncoordinated with each other.

The cell 1 configures the lowest priority through cell reselection priority control by taking account of congestion S1510. The cell 1 can be configured to apply the lowest priority over the whole frequency range of the E-UTRAN.

The cell 1 transmits mobility restriction information to the cell 2 as the lowest priority is configured S1520. The mobility restriction information can be transmitted between the cell 1 and the cell 2 through the X2 interface. The mobility restriction information can include lowest priority information. The lowest priority information can be configured so that the lowest priority is applied over the whole frequency range of the E-UTRAN.

Receiving the mobility restriction information, the cell 2 can operate on the basis of the mobility restriction information. The mobility restriction information-based operation may be characterized by the feature that a UE which attempts to approach the cell 2 or which has approached the cell 2 is prevented from being moved to the cell based on the frequency or RAT to which the lowest priority is applied. The mobility restriction information-based operation of the cell 2 can be implemented in such a way to last for a predetermined time period (T_{P}). As one example, if receiving the mobility restriction information, the cell 2 can perform mobility restriction information-based operation during a predetermined, specific time period. As another example, the mobility restriction information can include lowest priority duration information, and the cell 2 can perform mobility restriction information-based operation during a specified time period (T_{P}).

The UE transmits an RRC connection request message to the cell 1 to establish an RRC connection to the cell 1 S1531. Since the UE is unable to know whether the lowest priority is applied over the whole frequency range of the E-UTRAN, the UE can attempt to establish an RRC connection to approach the cell 1.

The cell 1 can reject the UE's attempt to establish a connection, and accordingly, the cell 1 transmits an RRC connection rejection message to the UE S1532. The RRC connection rejection message can include the lowest priority request information, and the lowest priority request can indicate that the lowest priority is applied over the whole frequency range of the E-UTRAN.

The UE performs cell reselection S1540. Since the lowest priority is applied over the whole frequency range of the E-UTRAN, the UE can select a cell belonging to the UTRAN as a target cell through cell reselection. In the present embodiment, it is assumed that the UE selects the cell 2, which is an UMTS cell, as the target cell.

The UE transmits an RRC connection request message to the cell 2 to establish an RRC connection to the cell 2 S1551. The UE can include pre-redirection information in the RRC connection request message, and the pre-redirection information can be configured to command the E-UTRAN to employ the RAT preferred by the UE.

The cell 2 can receive an RRC connection request message from the UE and determine whether to allow the UE to establish an RRC connection.

As in the existing methods, in case the cell 2 is not aware of the fact that the lowest priority is applied over the whole frequency range of the E-UTRAN, and the pre-redirection information included in the RRC connection request message indicates the E-UTRAN, the cell 2 can determine that it is preferable for the UE to establish an RRC connection to a cell belonging to the E-UTRAN and to receive a service from the corresponding cell; and transmit an RRC connection rejection message for redirection to the UE.

On the other hand, according to an embodiment of the present invention, since the cell 2 is aware of the fact that the lowest priority is being applied over the whole frequency range of the E-UTRAN by receiving mobility restriction information from the cell 1, the cell 2 can operate so that the UE can be prevented from being moved to a cell of the E-UTRAN. To this end, the cell 2 can be made to allow an RRC connection request of the UE and transmit an RRC connection configuration message to the UE S1552.

In response to the RRC connection configuration message, the UE transmits an RRC connection configuration completed message to the cell 2 to complete establishment of an RRC connection S1553.

As shown in FIG. 15, in case the mobility restriction information includes the lowest priority duration information, the cell 2 can perform mobility restriction information-based operation as described above during the time period (T_{P}) specified by the lowest priority duration information. In case the time period (T_{P}) is completed while an RRC connection of the UE to the cell 2 is being maintained, the cell 2 determines that the lowest priority is not applied any more to the frequency range of the E-UTRAN and regards the UE's receiving a service from a cell of the E-UTRAN as being preferable. Therefore, to let the UE approach a cell of the E-UTRAN, the cell 2 can determine to release the RRC connection of the UE and transmit an RRC connection release message to the UE S1560.

Also, in case the cell 2 receives an RRC connection request message from the UE after the time period (T_{P}) specified by the lowest priority duration information is completed, the cell 2 may determine that it is preferable for the UE to establish an RRC connection to a cell of the E-UTRAN and receive a service therefrom. Therefore, the cell 2 may transmit to the UE an RRC connection rejection message for redirection of the UE to the E-UTRAN or transmit a command to the UE after accepting an RRC connection request of the UE, which commands the UE to connect to the E-UTRAN.

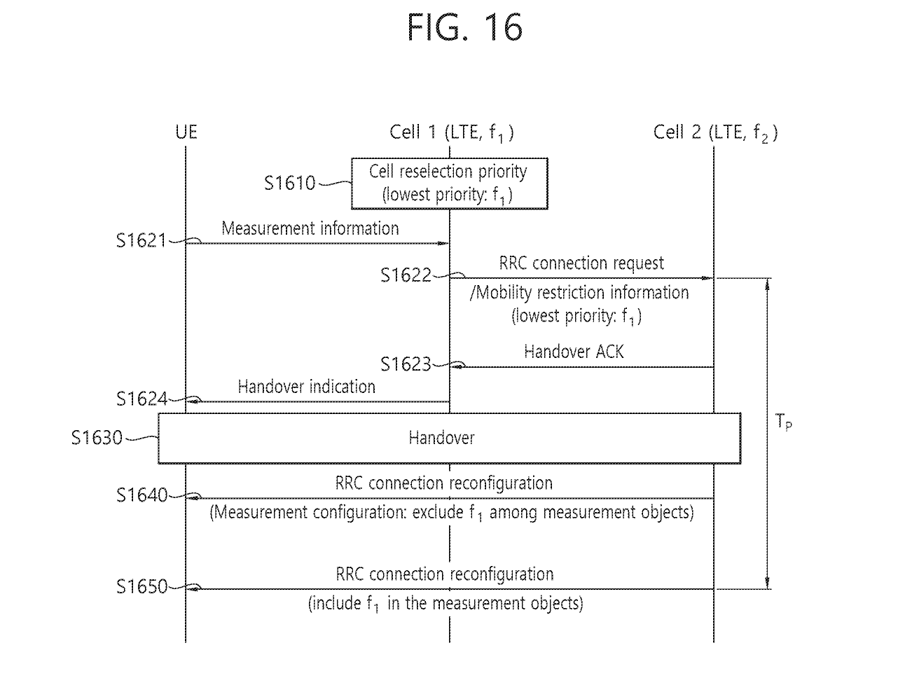

FIG. 16 illustrates another example of a communication method based on mobility restriction information according to an embodiment of the present invention.

In the example of FIG. 16, it is assumed that the UE is in an RRC connected state, and the cell 1 operates as a serving cell. It is also assumed that the cell 1 is an LTE cell operating at the frequency f1, and the cell 2 is an LTE cell operating at the frequency f2. It is further assumed that the cell 1 and the cell 2 are uncoordinated with each other. The UE can be configured to perform measurement and reporting on the frequencies in the LTE system.

The cell 1 configures the lowest priority through cell reselection priority control by taking account of congestion S1610. The cell 1 can be configured to apply the lowest priority to the frequency f1.

The UE reports to the cell 1 on a measurement result S1621. The measurement result can include a measurement result about the cell 1 which is a serving cell and a measurement result about the cell 2 which is a neighboring cell.

The cell 1 can determine to hand over the UE to the cell 2 on the basis of the UE's measurement result. Accordingly, the cell 1 and the cell 2 can perform a handover preparation procedure. The cell 1 transmits mobility restriction information to the cell 2 by including the mobility restriction information in a handover preparation message transmitted to the cell 2 for a handover preparation procedure S1622. The mobility restriction information can include lowest priority information. The lowest priority information can be configured to command application of the lowest priority with respect to the frequency f1 of the E-UTRAN. Through this operation, the cell 2 can perceive that the lowest priority is being applied with respect to the frequency f1.

The cell 2 transmits a handover preparation ACK message to the cell 1 in response to the handover preparation message S1623.

The cell 1 transmits to the UE a handover indication message to command to perform handing over the UE to the cell 2 S1624.

The UE performs a handover procedure in conjunction with the cell 2 according as a handover indication message is received S1630.

The cell 2 which has obtained mobility restriction information through the S1622 step can perform mobility restriction information-based operation. In the present embodiment, mobility restriction information-based operation may correspond to the case where the UE which has approached the cell 2 through handover moves back to a cell in the frequency f1. To this end, the cell 2 can transmit an RRC connection reconfiguration message to the UE to provide a new RRC configuration S1640.

The RRC connection reconfiguration message can include a measurement configuration to set up the UE's measurement and reporting operation. For example, the measurement configuration can set up the frequency f1 to be excluded from measurement objects. In case the UE performs measurement and reporting according to the measurement configuration received from the S1640 step, since the UE does not perform inter-frequency measurement with respect to the frequency f1, and the cell 2 is unable to get a measurement result with respect to the frequency f1, the UE's movement to the cell in the frequency f1 through handover can be prevented.

In the example of FIG. 16, in case mobility restriction information includes lowest priority duration information, the cell 2 can perform mobility restriction information-based operation as described above for the time period (T_{P}) specified by the lowest priority duration information since the time at which the mobility restriction information is received.

When the time period (T_{P}) is completed, the cell 2 can determine not to prevent the UE any more from being moved to a cell in the frequency f1, and to this end, the cell 2 can transmit an RRC connection reconfiguration message to the UE to provide a new RRC configuration to the UE S1650. For example, the RRC connection reconfiguration message can include a measurement configuration set up to include the frequency f1 as a measurement object. The UE which receives such a kind of measurement configuration can report on the measurement result obtained with respect to the frequency f1 and move to a cell in the frequency f1 according to a handover result.

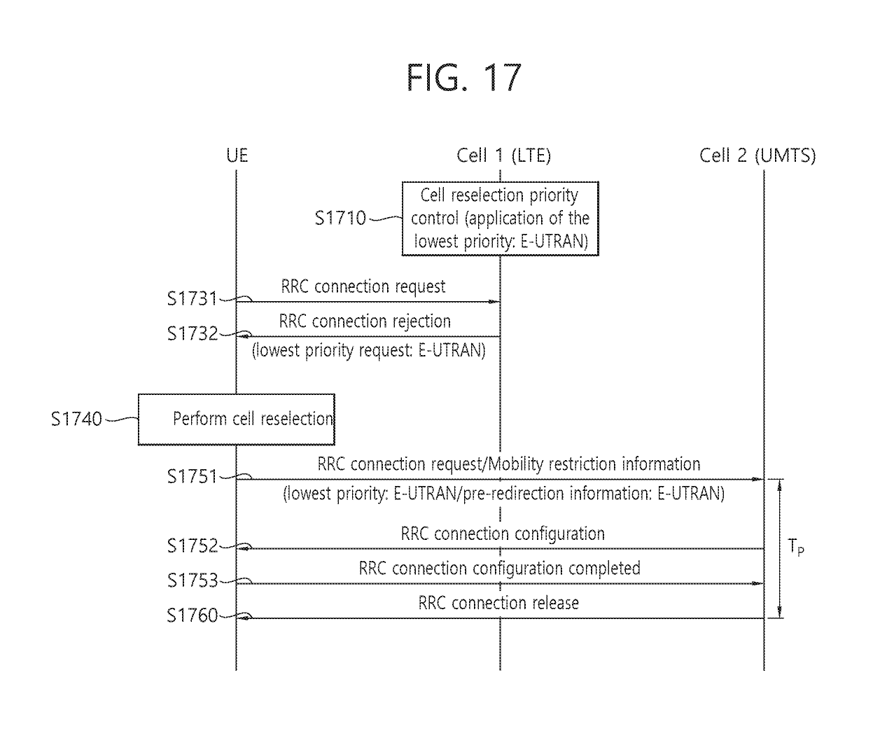

FIG. 17 illustrates a yet another example of a communication method based on mobility restriction information according to an embodiment of the present invention.

In the example of FIG. 17, it is assumed that the UE is in an RRC idle state, the cell 1 is an LTE cell, and the cell 2 is an UMTS cell. Also, it is assumed that the cell 1 and the cell 2 are uncoordinated with each other.

The cell 1 configures the lowest priority through cell reselection priority control by taking account of congestion S1710. The cell 1 can be configured to apply the lowest priority over the whole frequency range of the E-UTRAN.

The UE transmits an RRC connection request message to the cell 1 to establish an RRC connection to the cell 1 S1731. Since the UE is unable to know whether the lowest priority is applied over the whole frequency range of the E-UTRAN, the UE can attempt to establish an RRC connection to approach the cell 1.

The cell 1 can reject the UE's attempt to establish a connection, and accordingly, the cell 1 transmits an RRC connection rejection message to the UE S1732. The RRC connection rejection message can include the lowest priority request information, and the lowest priority request can indicate that the lowest priority is applied over the whole frequency range of the E-UTRAN. The lowest priority request information can include a lowest priority timer.

The UE performs cell reselection S1740. Since the lowest priority is applied over the whole frequency range of the E-UTRAN, the UE can select a cell belonging to the UTRAN rather than the E-UTRAN as a target cell through cell reselection. In the present embodiment, it is assumed that the UE selects the cell 2, which is an UMTS cell, as the target cell.

The UE transmits an RRC connection request message to the cell 2 to establish an RRC connection to the cell 2 S1751. The UE can include mobility restriction information in the RRC connection request message. The mobility restriction information can include the lowest priority information and pre-redirection information.

The lowest priority information can be configured to indicate that the lowest priority is applied over the whole frequency range of the E-UTRAN. The pre-redirection information can be configured to indicate the E-UTRAN as the RAT preferred by the UE. In addition, mobility restriction information can further include lowest priority duration information. The lowest priority duration information can be configured to specify duration on the basis of the lowest priority timer of the lowest priority request information obtained through the RRC connection rejection message or to specify specific duration independently.

Receiving the mobility restriction information, the cell 2 can operate on the basis of the mobility restriction information. The mobility restriction information-based operation may be characterized by the feature that a UE which attempts to approach the cell 2 or which has approached the cell 2 is prevented from being moved to the cell based on the frequency or RAT to which the lowest priority is applied. The mobility restriction information-based operation of the cell 2 can be implemented in such a way to last for a predetermined time period (T_{P}). As one example, if receiving the mobility restriction information, the cell 2 can perform mobility restriction information-based operation during a predetermined, specific time period. As another example, the mobility restriction information can include lowest priority duration information, and the cell 2 can perform mobility restriction information-based operation during a specified time period (T_{P}).

The cell 2 being operated on the basis of the mobility restriction information can receive an RRC connection request message from the UE and take into account the mobility restriction information in determining whether to allow the UE's RRC connection.

As in the existing methods, in case the cell 2 is not aware of the fact that the lowest priority is applied over the whole frequency range of the E-UTRAN, and the pre-redirection information included in the RRC connection request message indicates the E-UTRAN, the cell 2 can determine that it is preferable for the UE to establish an RRC connection to a cell belonging to the E-UTRAN and to receive a service from the corresponding cell; and transmit an RRC connection rejection message for redirection to the UE.

On the other hand, according to an embodiment of the present invention, since the cell 2 is aware of the fact that the lowest priority is being applied over the whole frequency range of the E-UTRAN by receiving mobility restriction information from the cell 1, the cell 2 can operate so that the UE can be prevented from being moved to a cell of the E-UTRAN. To this end, the cell 2 can be made to allow an RRC connection request of the UE and transmit an RRC connection configuration message to the UE S1752.

In response to the RRC connection configuration message, the UE transmits an RRC connection configuration completion message to the cell 2 to complete establishment of an RRC connection S1753.

As shown in FIG. 17, in case the mobility restriction information includes the lowest priority duration information, the cell 2 can perform mobility restriction information-based operation as described above during the time period (T_{P}) specified by the lowest priority duration information. In case the time period (T_{P}) is completed while an RRC connection of the UE to the cell 2 is being maintained, the cell 2 determines that the lowest priority is not applied any more to the frequency range of the E-UTRAN and regards the UE's receiving a service from a cell of the E-UTRAN as being preferable. Therefore, to let the UE approach a cell of the E-UTRAN, the cell 2 can determine to release the RRC connection of the UE and transmit an RRC connection release message to the UE S1760.

Also, in case the cell 2 receives an RRC connection request message from the UE after the time period (T_{P}) specified by the lowest priority duration information is completed, the cell 2 may determine that it is preferable for the UE to establish an RRC connection to a cell of the E-UTRAN and receive a service therefrom. Therefore, the cell 2 can transmit to the UE an RRC connection rejection message for redirection of the UE to the E-UTRAN.

According to an embodiment of the present invention, as mobility restriction information is provided to a target network node, the target network node can know the lowest priority setting for a movement of a UE. The target network node can perform network operation such as establishment of an RRC connection of a UE, handover, and RRC configuration on the basis of received mobility restriction information. As the target network node performs network operation, the UE can receive a more efficient service by moving to a more relevant cell in terms of service. Also, efficiency in terms of network operation can be further improved as unnecessary signaling between a UE and a network and/or between networks can be prevented.

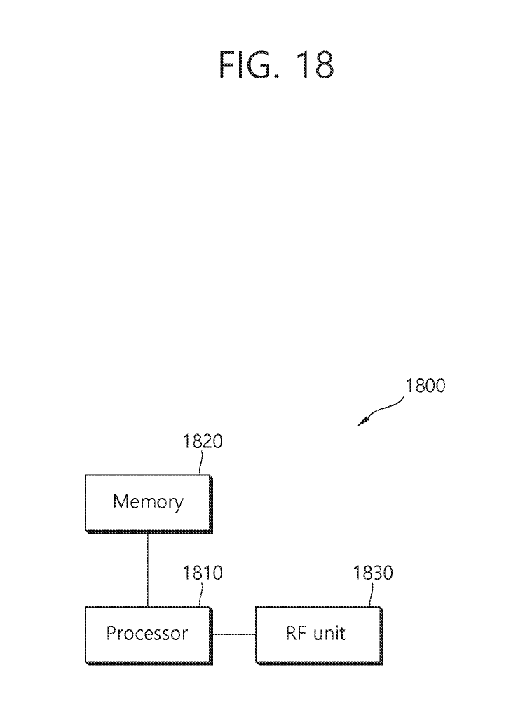

FIG. 18 is a block diagram of a wireless device to which an embodiment of the present invention is implemented. This device can be configured to embody the operating method based on mobility restriction information according to embodiments of the present invention described with reference to FIGS. 14 to 17.

With reference to FIG. 18, a wireless device 1800 comprises a processor 1810, memory 1820, and RF (Radio Frequency) unit 1830. The processor 1810 implements a proposed function, process and/or method. The processor 1810 can be configured to set up mobility restriction information. The processor 1810 can be configured to transmit and receive mobility restriction information. The processor 1810 can be configured to control mobility of a UE on the basis of the mobility restriction information. The processor 1810 can be configured to implement the embodiments of the present invention according to FIGS. 14 to 17.

The RF unit 1830, being connected to the processor 1810, transmits and receives a radio signal.

The processor may include application-specific integrated circuits (ASICs), other chipsets, logic circuits, and/or data processors. The memory may include read-only memory (ROM), random access memory (RAM), flash memory, memory cards, storage media and/or other storage devices. The RF unit may include a baseband circuit for processing a radio signal. When the embodiment described above is implemented in software, the scheme described above may be implemented using a module (process or function) which performs the function described above. The module may be stored in the memory and executed by the processor. The memory may be disposed inside or outside of the processor and connected to the processor using a variety of well-known means.

In the above exemplary systems, although the methods have been described based on the flow diagrams using a series of steps or blocks, the present invention is not limited to a particular order of the steps, and some of the steps may be performed in a different order from the remaining steps or may be performed simultaneously with the remaining steps. Furthermore, those skilled in the art will understand that the steps shown in the flow diagrams are not exclusive and may include other steps or one or more steps of the flow diagrams may be deleted without affecting the scope of the present invention.

What is claimed is:

1. A method for communication performed by a first base station in a wireless communication system, the method, comprising:
generating mobility restriction information related to movement control of a user equipment (UE); and
transmitting the mobility restriction information to a second base station,
wherein the mobility restriction information is transmitted between the first and the second base station through X2 interface.

2. The method of claim 1, wherein the mobility restriction information includes lowest priority information, and
the lowest priority information indicates that lowest priority is applied to at least one frequency or specific Radio Access Technology (RAT).

3. The method of claim 2, wherein the lowest priority information includes a frequency list about the at least one frequency to which the lowest priority is applied.

4. The method of claim 2, wherein the lowest priority information includes a frequency list about frequencies to which the lowest priority is not applied.

5. The method of claim 2, wherein the mobility restriction information further includes lowest priority duration information, and
the lowest priority duration information specifies duration for which the lowest priority is applied according to the lowest priority information.

6. The method of claim 2, wherein the mobility restriction information further includes lowest priority duration information, and
the lowest priority duration information specifies duration for which network is operated on the basis of the lowest priority information.

7. The method of claim 1, wherein the mobility restriction information includes lowest priority release information which indicates that application of the lowest priority to one or more frequencies or particular Radio Access Technology (RAT) has been released.

8. The method of claim 1, wherein the mobility restriction information is transmitted being included in a handover preparation message which is transmitted while a handover preparation procedure for handing over a UE from the first base station to the second base station is being performed.

9. The method of claim 1, further comprising receiving a request for transmitting the mobility restriction information from the second base station, wherein
the mobility restriction information is transmitted in response to the request.

10. The method of claim 1, wherein the first base station is an evolved Node B (eNB) of Evolved-UMTS Terrestrial Radio Access Network (E-UTRAN), and
the second base station is a Node B of UTRAN.

11. The method of claim 1, wherein the mobility restriction information forms a base for operating the second base station.

12. A user equipment (UE), the UE, comprising:
a Radio Frequency (RF) unit transmitting and receiving a radio signal; and
a processor functionally combined with the RF unit, wherein the processor is configured
to generate mobility restriction information related to movement control of a UE and
to transmit the mobility restriction information to a network node, wherein
the mobility restriction information is transmitted between the wireless device and the network node through X2 interface.

13. The UE of claim 12, wherein the mobility restriction information includes lowest priority information, and
the lowest priority information indicates that lowest priority is applied to at least one frequency or specific Radio Access Technology (RAT).
